(19) United States
(12) Patent Application Publication
(10) Pub. No.: US 2026/0252101 A1
(43) Pub. Date: Aug. 27, 2026

(54) MANAGEMENT OF PILED GRANULAR MATERIAL WITH VERTICAL SURFACE PROJECTIONS

(71) Applicant: Grain Weevil Corporation, La Vista, NE (US)

(72) Inventors: Travis Vanderheyden, Omaha, NE (US); Cole Oswald, Aurora, NE (US); Preston Parmley, Valley, NE (US); Benjamin H. Johnson, Omaha, NE (US); Ryan Baker, Bennington, NE (US); Alex Deleon, Omaha, NE (US); Chad E. Johnson, Omaha, NE (US)

(73) Assignee: Grain Weevil Corporation, La Vista, NE (US)

(21) Appl. No.: 19/077,443

(22) Filed: Mar. 12, 2025

Related U.S. Application Data
(60) Provisional application No. 63/761,731, filed on Feb. 21, 2025.

(51) Int. Cl. G05D 1/656; A01F 25/18; G05D 107/50; G05D 109/10

(52) U.S. Cl. CPC G05D 1/656; A01F 25/186; G05D 2107/50; G05D 2109/10

(57) ABSTRACT

A piled granular material management robot comprises an auger-based drive system, a memory, and a processor. The processor is coupled with the memory and configured to: control movement of the piled granular material management robot, via augers of the auger-based drive system, to traverse about a surface of piled granular material in a bulk store; and direct a traversal, by the piled granular material management robot, about a portion of the surface abutting an edge of a base of a sheer face of the piled granular material which projects vertically upward from the surface, such that the traversal of the portion erodes a segment of the base, by agitation with an auger of the auger-based drive system during the traversal of the portion, and incites a gravity induced collapse of a section of the sheer face.

### REFERENCE TO RELATED APPLICATIONS

This application claims priority to and benefit of U.S. Provisional Patent Application No. 63/761,731 filed on Feb. 21, 2025 entitled “MANAGEMENT OF PILED GRANULAR MATERIAL WITH VERTICAL SURFACE PROJECTIONS” by Vanderheyden et al., having Attorney Docket No. PING-016-PR, and assigned to the assignee of the present application, the disclosure of which is hereby incorporated herein by reference in its entirety.

### BACKGROUND

Some examples of granular material include, without limitation: grain (e.g., small hard and typically edible seeds or beans such as soybean seeds, peas, garbanzo beans, pinto beans, corn kernels, wheat, rice, etc.), non-grain plant seeds (e.g., flower seeds and grass seeds), nuts (e.g., shelled or unshelled tree nuts or ground nuts), nut shells, sand, animal litter, concrete mix, cement, dry fertilizer, pelletized products (e.g., wood pellets, plastic pellets, hemp pellets, fish food pellets, etc.) and granular milled/ground products (e.g., flour, soy meal, sugar, coffee, cocoa, guar gum, sodium bicarbonate, alumina, and granular mineral/rock aggregates/products, etc.). Granular material is often piled in a bulk store, either in the open or in a container such as a bin. Bulk stores, such as grain bins, are often hot, dirty, dusty, and dangerous workplaces. To adequately manage bulk stored granular materials farmers and/or other workers are required to enter bulk stores and/or climb about on the surface of a pile of the bulk stored granular material. Such interactions expose the farmer/worker to falls, entrapments, explosions, auger entanglements, heat stroke, and long-term conditions such as Farmer's Lung.

### BRIEF DESCRIPTION OF THE DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1 shows an example block diagram of some aspects of a device which moves about and/or operates in relation to a pile of granular material, in accordance with various embodiments.

FIG. 2 shows a block diagram of a collection of sensors, any, or all of which may be incorporated into the device of FIG. 1, in accordance with various embodiments.

FIG. 3 shows a block diagram of a collection of payloads, any, or all of which may be incorporated into the device of FIG. 1, in accordance with various embodiments.

FIGS. 4A-1, 4A-2, and 4A-3 illustrate front elevational views of the exterior of a device which moves about and/or operates in relation to a pile of granular material, in accordance with various embodiments.

FIGS. 4B-1 and 4B-2 illustrate rear elevational views of the exterior of a device which moves about and/or operates in relation to a pile of granular material, in accordance with various embodiments.

FIGS. 4C-1 and 4C-2 illustrate right elevational views of the exterior of a device which moves about and/or operates in relation to a pile of granular material, in accordance with various embodiments.

FIGS. 4D-1 and 4D-2 illustrate left elevational views of the exterior of a device which moves about and/or operates in relation to a pile of granular material, in accordance with various embodiments.

FIGS. 4E-1 and 4E-2 illustrate bottom plan views of the exterior of a device which moves about and/or operates in relation to a pile of granular material, in accordance with various embodiments.

FIG. 4F illustrates a top plan view of the exterior of a device which moves about and/or operates in relation to a pile of granular material along with a chart illustrating directional movements, in accordance with various embodiments.

FIG. 4G illustrates an upper front right perspective view of the exterior of a device which moves about and/or operates in relation to a pile of granular material, in accordance with various embodiments.

FIG. 4H illustrates an upper front right perspective view of the exterior of a device which moves about and/or operates in relation to a pile of granular material and which includes a separate auger payload/implement, in accordance with various embodiments.

FIG. 4I illustrates an upper front right perspective view of the exterior of a device which moves about and/or operates in relation to a pile of granular material and which includes a separate broom payload/implement, in accordance with various embodiments.

FIG. 5 illustrates some example embodiments of a bulk store slope adjustment system, in accordance with various embodiments.

FIG. 6 illustrates some example embodiments of a bulk store slope adjustment system, in accordance with various embodiments.

FIG. 7A illustrates an example bulk store for granular material, in accordance with various embodiments.

FIG. 7B illustrates a side sectional view A-A of an example bulk store for granular material which shows a device moving about and/or operating in relation to a portion of piled granular material in the bulk store, in accordance with various embodiments.

FIG. 7C illustrates a top sectional view B-B of an example bulk store for granular material which shows a device moving about and/or operating in relation to a portion of piled granular material in the bulk store, in accordance with various embodiments.

FIG. 7D illustrates a top sectional view B-B of an example bulk store for granular material which shows pattern for moving a device about and/or operating in relation to a portion of piled granular material in the bulk store, in accordance with various embodiments.

FIG. 7E illustrates a top sectional view B-B of an example bulk store for granular material which shows pattern for moving a device about and/or operating in relation to a portion of piled granular material in the bulk store, in accordance with various embodiments.

FIG. 7F illustrates a top sectional view B-B of an example bulk store for granular material which shows pattern for moving a device about and/or operating in relation to a portion of piled granular material in the bulk store, in accordance with various embodiments.

FIG. 7G illustrates a side sectional view A-A of an example bulk store for granular material which shows a device moving about and/or operating in relation to a portion of piled granular material in the bulk store, in accordance with various embodiments.

FIG. 7H illustrates a side sectional view A-A of an example bulk store for granular material which shows a device moving about and/or operating in relation to a portion of piled granular material in the bulk store, in accordance with various embodiments.

FIG. 7I illustrates a side sectional view A-A of an example bulk store for granular material which shows a device moving about and/or operating in relation to a portion of piled granular material in the bulk store, in accordance with various embodiments.

FIG. 7J illustrates a side sectional view A-A of an example bulk store for granular material which shows a device moving about and/or operating in relation to a portion of piled granular material in the bulk store, in accordance with various embodiments.

FIG. 7K illustrates a side sectional view A-A of an example bulk store for granular material which shows a device moving about and/or operating in relation to a portion of piled granular material in the bulk store, in accordance with various embodiments.

FIG. 7L illustrates a side sectional view A-A of an example bulk store for granular material which shows a device moving about and/or operating in relation to a portion of piled granular material in the bulk store, in accordance with various embodiments.

FIGS. 8A-8E illustrate a flow diagram of an example method of bulk store slope adjustment, in accordance with various embodiments.

FIGS. 9A and 9B illustrate external views of an example rectangular bulk store within which granular material may be stored, in accordance with various embodiments.

FIGS. 10A-10F illustrate various sectional views of the rectangular bulk store of FIGS. 9A and 9B along with an example pile of granular material with the robot of FIG. 4A1-4H performing piled granular material management in an environment which has a pillar of piled granular material vertically projecting from the surface, in accordance with various embodiments.

FIGS. 11A-11J illustrate various sectional views of the rectangular bulk store of FIGS. 9A and 9B along with an example pile of granular material with the robot of FIG. 4A1-4H performing piled granular material management in an environment which has a cliff of piled granular material vertically projecting from the surface, in accordance with various embodiments.

FIGS. 12A-12C illustrate a flow diagram of an example method of piled granular material management, in accordance with various embodiments.

FIGS. 13A-13B illustrate a flow diagram of an example method of piled granular material management, in accordance with various embodiments.

### DETAILED DESCRIPTION

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well-known methods, procedures, components, and circuits have not been described in detail as not to unnecessarily obscure aspects of the described embodiments.

### Overview of Discussion

A device which can operate via remote controlled instruction, autonomously, or some combination thereof is described. The device is robotic and may be referred to herein as a “robot” or as a “robotic device,” or the “device,” and includes an auger-based drive system which facilitates the movement and/or operation of the device in relation to a portion of piled granular material in a bulk store, such as a grain bin. More particularly, because of the augers in the auger-based drive system, the device can operate and maneuver (i.e., drive about) upon or beneath piled granular material. Additionally, and advantageously, augers of the auger-based drive system move, disrupt, agitate, and/or disperse piled granular material as a consequence of the movement of the device.

Although tracked and wheeled devices would seem to be alternatives to the auger-driven devices described herein, both wheeled and tracked drive systems have been found ill-suited to operation on piled granular material. For example, wheeled and tracked devices are both easily bogged down when operating on piled granular material, such that they exhibit poor mobility in traversing atop/upon deeply piled granular material (e.g., over a foot deep, and sometimes not even that deep). In short, they frequently get stuck and require human retrieval or intervention, which typically necessitates a human undesirably entering upon the pile of granular material.

Herein, the term “granular material” refers to the physical collection of granules. Some examples of granular material include, without limitation: grain (e.g., small hard and typically edible seeds or beans such as soybean seeds, peas, garbanzo beans, pinto beans, corn kernels, wheat, rice, etc.), non-grain plant seeds (e.g., flower seeds and grass seeds), nuts (e.g., shelled or unshelled tree nuts or ground nuts), nut shells, sand, animal litter, concrete mix, cement, dry fertilizer, pelletized products (e.g., wood pellets, plastic pellets, hemp pellets, fish food pellets, etc.) and granular milled/ground products (e.g., flour, soy meal, sugar, coffee, cocoa, guar gum, sodium bicarbonate, alumina, and granular mineral/rock aggregates/products, etc.). “Bulk solid” is a term that may be used to generally describe non-grain granular materials. Granular material is often piled (i.e., heaped up) in a bulk store.

Herein, the term “granular medium” describes the bulk behavior and interaction of granular material as a system.

A bulk store is the place where granular material is piled for bulk storage. Although a grain bin is frequently used herein as an example of a bulk store, nearly any bulk store which is large enough for a human to access and work inside or upon the stored granular material is a candidate for operation of the device described herein. Accordingly, it should be appreciated that other large bulk stores are also suitable bulk stores for use of the described device in relation to piled granular material in many of the manners described herein. Some examples of other large bulk stores include, but not limited to: containers (e.g., railcars, semi-trailers, barges, ships, which may be enclosed or have open tops, and the like) for transport/storage of granular material, upright metal storage, buildings (e.g., silos, bins, warehouses, flat storage, government grain storage, etc.) for storage of granular material, and open storage piles of granular material.

Bulk stored granular material can present many safety concerns for humans. For example, bulk stores are often hot, dusty, poorly lit, and generally inhospitable work environments for humans. Additionally, entrapments can take place when a farmer or worker is in a bin or other bulk store of granular material, such as grain, and the granular material slides onto or engulfs the person. Entrapments can happen because a slope angle of the piled granular material (e.g., grain) is at a critical angle which may slide when disturbed by the person or else when may slide when extraction augers or machinery disturb the bulk stored granular material. As one example, steep walls of grain can avalanche onto a farmer/worker trying to mitigate problems in a grain bin, inspect the stored grain, or agitate the grain to improve the outflow. Additionally, sometimes a bridge/crust layer can form over a void in a pile of grain and when a farmer/worker walks across it or tries to break it with force, the grain bridge can collapse and entrap the person. As this bridge/crust layer and/or the size of the void below it may be invisible to the human eye, it can present an unknown danger to a farmer/worker. Furthermore, in some piled granular materials, localized compaction can cause vertical projections which from the surface to appear as granular material is removed from a bulk store. Such vertical projections include cliffs (which may have a sheer face on at least one side and a second side coupled with a wall of the bulk store) and stand-alone pillars (also called towers, and which have at least one sheer face but do not have a side coupled with a wall of the bulk store). By sheer face, what is meant is an expanse of compacted granular material that extends generally in a vertical direction from an adjacent surface of the granular material. The occurrence of these vertical projections is often called “cliffing” and/or “pillaring.” Generally, these vertical projections occur when the pressure from the piled up granular material causes localized interlocking in the granular material that comprises the vertical projection. The localized interlocking is a result of compression due to the weight of the piled granular material, and it is friction-based, rather than a permanent organic binding. In some instances, the presence of too much moisture in the piled granular material increases the occurrence of the localized interlocking. The localized interlocking prevents free flow of the compacted granular material as other non-compacted granular material around a cliff or pillar is removed. Such vertical projections can often be very tall (e.g., 10 to 50 feet, or more). Thus, if they topple on a human severe injury may occur. As will be discussed, many of these and other safety concerns can be reduced or eliminated through use of the device and techniques/methods described herein.

Among other things, the device described herein can be used to address managing the quality of bulk stored granular material (e.g., grain in a bin) through tasks like, but not limited to: inspections of the bulk stored granular material, leveling of the bulk stored granular material, agitating of the bulk stored granular to prevent/reduce spoilage, traversing a surface of granular material to break up a crust and/or prevent crust formation, dispersing of the bulk stored granular material while it is being loaded into the bulk store, assisting with rehydration of grain to a higher test weigh prior to extraction, assisting with extraction of grain, feeding a sweep auger or other collection device which removes the bulk stored granular material from the bulk store, lowering the slope angles of the granular material in a partially emptied bulk store, and/or reducing/eliminating vertical projections (e.g., cliffs and pillars) of the granular material which extend vertically upward from the surface. In short, the device can accomplish numerous tasks which, when done by the device, preclude the need for humans to enter a bulk store, work on a pile of granular material, or else make it safer when it is necessary for humans to enter a bulk store or work on a pile of granular material. In various embodiments, these tasks may be carried out: by the device under remote-control of the device by an operator located outside the bulk store; by the device in an ad-hoc fashion; by the device in a partially automated fashion; and/or by the device in fully automated fashion. Employment of the device relative to a bulk stored granular material reduces or eliminates the requirement for a human to enter a bulk store or personally traverse the piled granular material. As a consequence, safety to humans is drastically improved with regard to tasks related to management of a bulk store. In an event where a human chooses to enter a bulk store, the device can manage/prepare the surface by removing crusts, eliminating grain bridges, eliminating vertical projections, and reducing slope so that the piled granular material is safer for human traversal.

Additionally, as an extension of the device traversing atop/upon the surface of piled granular material, the device can note and record its locations at a plurality of points on the surface such that a mapping of the three-dimensional contours of the upper surface of the piled granular material in the bulk store can be constructed of the points of location of the device. The mapping can further include environmental characteristics measured at respective locations upon the surface. Several surface maps can be sequentially captured during the filling of a bulk store such that when compiled a three-dimensional map is assembled which illustrates environmental characteristics not only on the surface of the piled granular material, but also beneath the existing surface at the levels of previous surfaces where mapping was accomplished prior to the filling of additional granular material. Such mappings have many beneficial uses. For example, a surface contour map can be combined with information regarding test weights (i.e., moisture levels) of piled grain and the location of the floor of the bulk store to estimate an amount of granular material (e.g., grain) stored in the bulk store (i.e., a number of bushels or other weight or volume). In another example, a surface contour map can be utilized to determine whether and where surface leveling should be performed by the device. In another example, an environmental characteristics map can indicate one or more areas of concern which may need to be cooled, dispersed, or otherwise attended to by the robotic device described herein. Put more generally, data collected by the device while traversing the surface of a piled granular material in a bulk store (e.g., a grain bin) is used to assist a human (e.g., a farmer, worker, etc.) in managing the bulk store and the piled granular material during loading, storage, and unloading of the piled granular material.

Additionally, as an extension of the device traversing atop/upon the surface of piled granular material and in some instances as a function of mapping as well, the device operates as a grain bin assistant in the management of the grain that is stored within a bulk store such as a grain bin. That is, the device may operate to assist with management of a grain bin: prior to load-in of grain, during load-in of grain, after load-in, during storage, during extraction of grain, and/or during clean-out of grain from a bin. This may include one or more of: the device operating to level, map, aerate, and/or prepare the surface of any grain already in a grain bin to prepare the bin for load-in of additional grain; the device operating during load-in of a load of grain to disperse BGFM which typically accumulates in the landing zone of the loaded-in grain; the device operating during/after the load-in of a load of grain to level, map, remediate hot spots, and/or aerate the surface of grain; the device operating to prepare the upper surface of the loaded-in grain either for long term storage or load-in of an additional load; the device operating to maintain and/or inspect the surface of the grain during long term storage; the device operating to assist with rehydration of stored grain prior to extraction; the device operating to assist with extraction by leveling the surface, mapping the surface, and/or pushing grain to the center/extraction point through one or more of the action of the augers of the device and purposely inciting sediment gravity flow of grain; and/or the device operating with clean-out of the grain bin by running one or more patterns to move grain to a sweep auger or other extraction point/tool at the bottom of the bin through one or more of the action of the augers of the device and purposely inciting sediment gravity flow of grain.

Discussion begins with a description of notation and nomenclature. Additional discussion is divided into sections. In Section 1, discussion is directed to description of some block diagrams of example components of some examples of a robotic auger-driven “device” which moves about atop/upon and/or operates in relation to a bulk stored pile of granular material. A variety of sensors and payloads which may be included with and/or coupled with the device are described. Numerous example views of the exterior of a device are presented and described, to include description of the auger-based drive system of the device. Several systems for remote-controlled semi-autonomous, and autonomous operation of the device are described. Additionally, systems and techniques for storing information from the device and/or providing information and/or instructions to the device are described. In Section 2, an example bulk store for granular material is then depicted and described in conjunction with operation of the device in relation to piled granular material in the bulk store. Operation of the device and components thereof, to include some sensors of the device, are discussed in conjunction with a variety of methods/modes of operation. For example, operation of the device is discussed in conjunction with description of an example method of bulk store leveling. In Section 3, an example bulk store for granular material is then depicted and described in conjunction with operation of the device in relation to piled granular material in the bulk store. For example, techniques and methods for using the robot/device to manage a piled granular material which includes one or more vertical projections of granular material, such as pillars and/or cliffs, projecting upwards from the surface.

### Section 1

### Notation and Nomenclature

Some portions of the detailed descriptions which follow are presented in terms of procedures, logic blocks, processes, modules, and other symbolic representations of operations on data bits within a computer memory. These descriptions and representations are the means used by those skilled in the data processing arts to most effectively convey the substance of their work to others skilled in the art. In the present application, a procedure, logic block, process, module, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device/component.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “accessing,” “additionally traversing,” “articulating,” “assembling,” “capturing,” “ceasing,” “ceasing traversal,” “collecting,” “communicating,” “communicatively coupling,” “continuing,” “continuing traversal,” “controlling,” “coupling,” “delivering,” “depositing,” “determining,” “directing,” “directing traversal,” “failing to satisfy,” “inciting,” “instructing,” “mapping,” “measuring,” “obtaining,” “performing,” “placing,” “providing,” “providing access,” “receiving,” “receiving data,” “receiving instructions,” “recording,” “relaying,” “responding,” “rotatably articulating,” “satisfying,” “sending,” “sensing,” “traversing,” “undercutting,” “using,” and “utilizing,” or the like, refer to the actions and processes of an electronic device or component such as (and not limited to): a host processor, a sensor processing unit, a sensor processor, a digital signal processor or other processor, a memory, a sensor (e.g., a temperature sensor, motion sensor, etc.), a computer, a remote controller, a device which moves about and/or operates in relation to a portion of piled granular material, some combination thereof, or the like. The electronic device/component manipulates and transforms data represented as physical (electronic and/or magnetic) quantities within the registers and/or memories into other data similarly represented as physical quantities within memories and/or registers or other such information storage, transmission, processing, and/or display components.

Embodiments described herein may be discussed in the general context of processor-executable instructions residing on some form of non-transitory processor-readable medium, such as program modules or logic, executed by one or more computers, processors, or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example electronic device(s) described herein may include components other than those shown, including well-known components.

The techniques described herein may be implemented in hardware, or a combination of hardware with firmware and/or software, unless specifically described as being implemented in a specific manner. Any features described as modules or components may also be implemented together in an integrated logic device or separately as discrete but interoperable logic devices. If implemented in software, the techniques may be realized at least in part by a non-transitory computer/processor-readable storage medium comprising computer/processor-readable instructions that, when executed, cause a processor and/or other components of a computer, computer system, or electronic device to perform one or more of the methods and/or actions of a method described herein. The non-transitory computer/processor-readable storage medium may form part of a computer program product, which may include packaging materials.

The non-transitory processor-readable storage medium (also referred to as a non-transitory computer-readable storage medium) may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a plurality of microprocessors, one or more microprocessors in conjunction with an ASIC or DSP, or any other such configuration or suitable combination of processors.

Example Block Diagrams of a Device which Moves About and/or Operates in Relation to a Pile of Granular Material

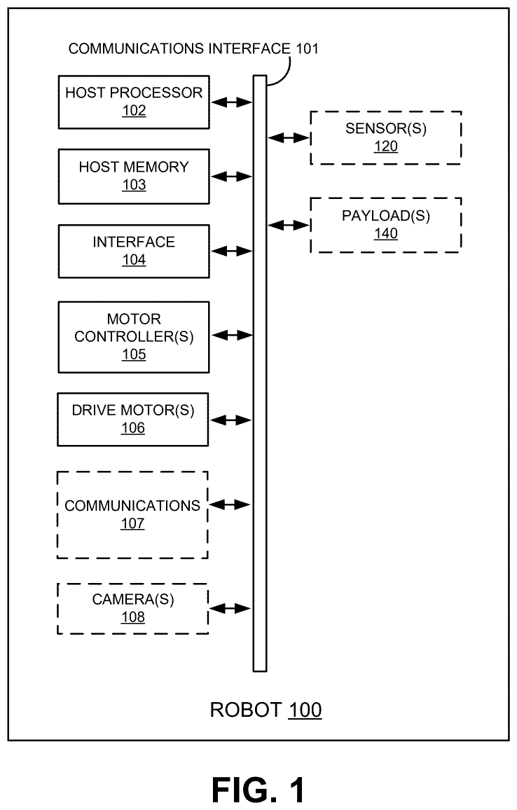

FIG. 1 shows an example block diagram of some aspects of a device 100 which moves about and/or operates in relation to a pile of granular material, in accordance with various embodiments. As previously discussed, device 100 may be referred to as a robot and/or robotic device, and device 100 may carry out some or all of its functions and operations based on stored instructions.

As shown, example device 100 comprises a communications interface 101, a host processor 102, host memory 103, an interface 104, motor controllers 105, and drive motors 106. In some embodiments, device 100 may additionally include one or more of communications 107, a camera(s) 108, one or more sensors 120, and/or one or more payloads 140.

Communications interface 101 may be any suitable bus or interface which facilitates communications among/between components of device 100. Examples of communications interface 101 include a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, or other equivalent and may include a plurality of communications interfaces.

The host processor 102 may, for example, be configured to perform the various computations and operations involved with the general function of device 100 (e.g., sending commands to move, steer, avoid obstacles, and operate/control the operation of sensors and/or payloads). Host processor 102 can be one or more microprocessors, central processing units (CPUs), DSPs, general purpose microprocessors, ASICs, ASIPs, FPGAs or other processors which run software programs or applications, which may be stored in host memory 103, associated with the general functions and capabilities of device 100.

Host memory 103 may comprise programs, modules, applications, or other data for use by host processor 102. In some embodiments, host memory 103 may also hold information that that is received from or provided to interface 104, motor controller(s) 105, communications 107, camera(s) 108, sensors 120, and/or payloads 140. Host memory 103 can be any suitable type of memory, including but not limited to electronic memory (e.g., read only memory (ROM), random access memory (RAM), or other electronic memory).

Interface 104 is an external interface by which device 100 may receive input from an operator or instructions. Interface 104 is one or more of a wired or wireless transceiver which may provide connection to an external transmission source/recipient for receipt of instructions, data, or direction to device 100 or offload of data from device 100. One example of an external transmission source/external recipient may be a base station to which device 100 communicates collected data or from which device 100 receives instructions or direction. Another example of an external transmission source/recipient is a handholdable remote-controller to which device 100 communicates collected data or from which device 100 receives instructions or direction. By way of example, and not of limitation, in various embodiments, interface 104 may comprise one or more of: a cellular transceiver, a wireless local area network transceiver (e.g., a transceiver compliant with one or more Institute of Electrical and Electronics Engineers (IEEE) 802.11 specifications for wireless local area network communication (e.g., Wi-Fi)), a wireless personal area network transceiver (e.g., a transceiver compliant with one or more IEEE 802.15 specifications (or the like) for wireless personal area network communication), and a wired a serial transceiver (e.g., a universal serial bus for wired communication).

Motor controller(s) 105 are mechanism(s), typically circuitry and/or logic, which operate under instruction from processor 102 to drive one or more drive motors 106 with electricity to govern/control the direction and/or speed of rotation of the drive motor(s) 106 and/or or other mechanism of movement to which the drive motor(s) 106 are coupled (such as augers). Motor controller(s) 105 may be integrated with or separate from drive motor(s) 106.

Drive motor(s) 106 are electric motors which receive electrical input from motor controller(s) 105 and turn a shaft in a direction and/or speed responsive to the electrical input. In some embodiments, drive motors 106 may be coupled directly to a mechanical means of drive motivation and steering—such as one or more augers. In some embodiments, drive motors 106 may be coupled indirectly, such as via a gearing or a transmission, to a mechanical means of drive motivation and steering—such as one or more augers.

Communications 107, when included, may comprise external interfaces in addition to those provided by interface 104. Communications 107 may facilitate wired and/or wireless communication with devices external to and in some instances remote (e.g., many feet or even many miles away) from device 100. Communications protocols may include those used by interface 104 as well as others. Some examples include, but are not limited to: Wi-Fi, LoRaWAN (e.g., long range wireless area network communications on the license-free sub-gigahertz radio frequency bands), IEEE 802.15.4-2003 standard derived communications (e.g., xBee), IEEE 802.15.4 based or variant personal area network (e.g., Bluetooth, Bluetooth Low Energy, etc.), cellular, and connectionless wireless peer-to-peer communications (e.g., ESP-NOW). In various aspects, communications 107 may be used for data collection/transmission, reporting of autonomous interactions of device 100, and/or user interface and/or operator interface with device 100.

Camera(s) 108 may comprise, without limitation: any type of optical sensor or infrared image sensor for capturing still or moving images. Some examples of suitable cameras include charge-coupled device (CCD) sensor cameras, metal-oxide semiconductor (MOS) sensor cameras, and other digital electronic cameras. Captured images may be utilized by device 100 for purposes such as navigation and decision making, may be stored, and/or may be transmitted to devices external to device 100. In some embodiments, camera(s) 108 facilitate wayfinding for device 100 when operating autonomously or semi-autonomously. In some embodiments, camera(s) 108 facilitates a remote view for an operator when device 100 is manually driven by a human user via a remote controller or computer system communicatively coupled with device 100. In some embodiments, an infrared camera 108 is used to find hotspots of grain to mix or agitate with device 100 (to reduce the heat of the hotspot). In some embodiments, computer vision is used by device 100 to make autonomous decisions based on inputs to processor 102 from camera(s) 108.

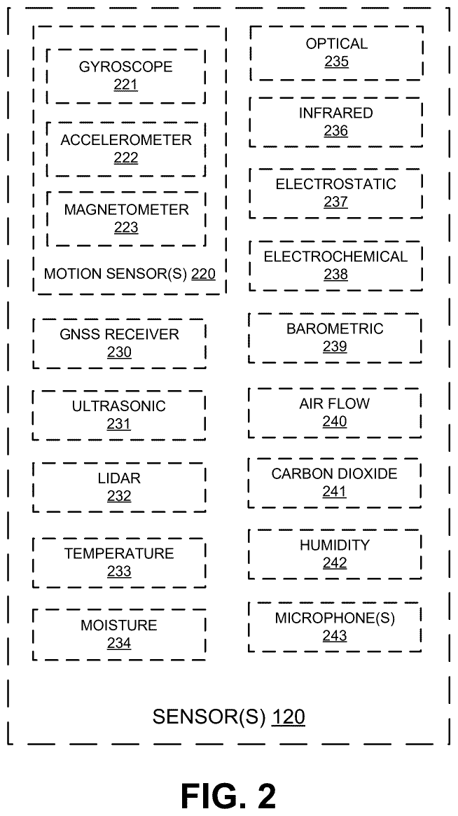

FIG. 2 shows block diagram of a collection of sensors 120, any or all of which may be incorporated device 100 of FIG. 1, in accordance with various embodiments. Sensors 120 illustrate a non-limiting selection of sensors, which include: motion sensor(s) 220, GNSS (Global Navigation Satellite System) receiver 230, ultrasonic transducer 231, LIDAR (light detection and ranging/laser imaging, detection, and ranging) 232, temperature sensor 233, moisture sensor 234, optical sensor 235, (e.g., an optical camera), infrared sensor 236 (which may be a receiver such as an infrared camera or an emitter/receiver), electrostatic sensor 237, electrochemical sensor 238, a barometric pressure sensor 239, an air flow sensor 240, a carbon dioxide sensor 241, and a humidity sensor.

It is appreciated that one or more sensors may be combined. For example, several sensors may be combined in a device such as the ICM-20789 microelectromechanical sensor (available from InvenSense, a TDK group company, of San Jose, CA) which provides 7-axis sensing (3-axis accelerometer, 3-axis gyroscope, and 1-axis barometric pressure (for measuring elevation changes to less than 8.5 cm accuracy)) along with an on-board digital motion processor. In other embodiments, separate sensors may be used; for example, a stand-alone pressure sensor 239 may measure elevation, via differential barometric pressure measurement, of as little as 5 cm (e.g., InvenSense sensor ICP-10101, as one example) while a motion sensor 220 includes an accelerometer 222 for measuring movement and a gyroscope 221 for measuring direction of movement). Other sensors may be additionally or alternatively included in some embodiments, for example a carbon dioxide sensor 241, and humidity sensor 242 may be included to measure off-gassed carbon dioxide from piled grain, and/or an air flow sensor may be included to measure air flow through and around piled grain (air flow is used for drying the pile of grain but must be controlled to prevent over drying or undesired rehydration). In some embodiments, one or more microphones 243, may be included as sensors. For example, an array of microphones may be used with a beamforming technique to locate the directional source of a sound, such as falling granular material being poured, conveyed, streamed, or augured into a bulk store. Some embodiments may additionally, or alternatively, include other sensors not described.

In general, individual sensors 120 operate to detect motion, position, timing, and/or some aspect of environmental context (e.g., temperature, atmospheric humidity, moisture of a sample or probed portion of granular material, distance to an object, shape of an object, solidity of a material, light or acoustic reflectivity, ambient charge, atmospheric pressure, presence of certain chemical(s), noise/sound, etc.). For example, in an embodiment where the piled granular material is grain, many of sensors 120 are used to determine the state of the grain (e.g., temperature, moisture, electrostatic charge, etc.). In some embodiments, one or more sensors 120 are used for fall detection, orientation, and to aid in autonomous direction of movement of device 100. For example, by detecting temperature of grain, device 100 may determine hot spots which need to be mixed by traversal with device 100 or by other means. Similarly, by detecting moisture of grain, device 100 may determine moist spots which need to be mixed by traversal with device 100 or by other means. By detecting an electrostatic and/or electrochemical aspect of the atmosphere in a grain bin, a level of dust or other particulates and/or likelihood of an explosion may be detected in order to gauge safety for a human and/or safety for operating device 100.

Some embodiments may, for example, comprise one or more motion sensors 220. For example, an embodiment with a gyroscope 221, an accelerometer 222, and a magnetometer 223 or other compass technology, which each provide a measurement along three axes that are orthogonal relative to each other, may be referred to as a 9-axis device. In another embodiment three-axis accelerometer 222 and a three-axis gyroscope 221 may be used to form a 6-axis device. Other embodiments may, for example, comprise an accelerometer 222, gyroscope 221, compass, and pressure sensor, and may be referred to as a 10-axis device. Other embodiments may not include all these motions sensors or may provide measurements along one or more axes. In some embodiments, motion sensors 220 may be utilized to determine the orientation of device 100, the angle of slope or inclination of a surface upon which device 100 operates, the velocity of device 100, and/or the acceleration of device 100. In various embodiments, measurements from motion sensors 220 may be utilized by host processor 102 to measure direction and distance of travel and may operate as an inertial navigation system (INS) suitable for controlling and/or monitoring maneuvering of device 100 in a bulk store (e.g., within a grain bin). In some embodiments, motion sensors 220 may be used for fall detection. In some embodiments, motions sensor(s) 220 may be used to detect vibrations in the granular material proximate to device 100.

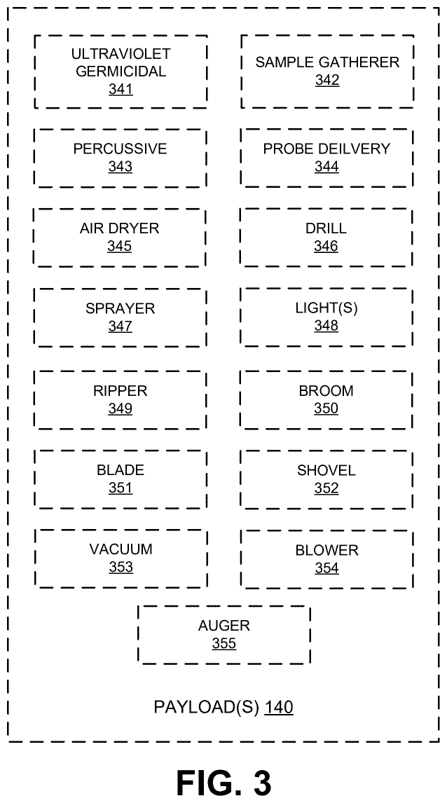

FIG. 3 shows a block diagram of a collection of payloads 140, any or all of which may be incorporated device 100 of FIG. 1, in accordance with various embodiments. Payloads 140 illustrate a non-limiting selection of payloads, which include: ultraviolet germicidal 341, sample gatherer 342, percussive payload 343, probe/sensor delivery 344, air dryer 345, drill 346, sprayer 347, lights 348, ripper 349, broom 350, blade 351, shovel 352, vacuum 353, a blower 354, and/or an auger 355.

Ultraviolet germicidal payload 341, when included, emits ultraviolet light to kill germs by irradiating in the proximity of device 100. Sample gatherer payload 342, when included, provides one or more containers or bays for gathering one or more samples of granular material from a pile of granular material upon which device 100 operates. Percussive payload 343, when included, operates to vibrate, or percussively impact piled granular material touching or in the proximity of device 100. Probe/sensor delivery payload 344, when included, operates to insert one or more probes or sensors into piled granular material upon which device 100 operates and/or to position one or more probes onto piled granular material upon which device 100 operates. Air dryer payload 345, when included, provides a fan and/or heater for drying piled granular material proximate to device 100. Drill payload 346, when included, operates to bore into and/or sample piled granular material and/or break up crusts or aggregations of piled granular material proximate to device 100. Sprayer payload 347, when included, operates to spray fungicide, insecticide, or other liquid or powdered treatments onto piled granular material proximate device 100. Lights payload 348, when included, emit optical and/or infrared illumination in proximity of device 100. Ripper payload 349, when included, comprises one or more blades, tines, or the like and is used to rip into, agitate, and/or break up crusts or chunks of aggregated granular material proximate device 100. Broom payload 350, when included, may be include fixed or rotating components for sweeping. Blade 351, when included, may be a fixed or movable blade (e.g., similar to a dozer blade) for pushing/sweeping granular material in the path of traversal of device 100. Shovel 352, when included, may be a fixed or movable shovel (e.g., similar in appearance/function to a show shovel) relative to device 100 and is used for pushing/scooping/shoveling granular material in the path of traversal of device 100. In some embodiments, blade 351 and shovel 352 may have some similarity and perform some functions which overlap, though a blade 351 is generally suited more toward pushing than scooping granular material, while and while a shovel 352 may push granular material it is generally better configured for scooping than blade 351. Vacuum 353, when included, may be a powered vacuum that is fixed or movable relative to device 100 and is used for sucking up and storing granular material in the path of traversal of device 100. Blower 354, when included, may be a powered air blower that is fixed or movable relative to device 100 and is used for blowing granular material in the path of traversal of device 100.

Auger payload 355, when included, may provide a powered auger as an implement that is independent of and in addition to the augers 403 of the auger-based drive system of device 100. The angle of auger payload 355 may be fixed or movable relative to device 100. Auger payload 355 is used for agitating, grinding and/or moving granular material in the path of traversal of device 100. In some embodiments, auger payload may also be used to provide propulsion, in addition to the propulsion of augers 403 of the auger-based drive system.

It should be appreciated that various payloads may be delivered, where delivery includes leaving or expelling the payload or a portion thereof at a designated location. For example, delivery can include leaving/installing a probe or sensor. Delivery may also include spraying or spreading a substance such as, but not limited to: a coolant, a flame retardant, an insecticide, a fungicide, or other liquid, gas, or powder.

In various embodiments, one or some combination of payloads 140 may be included in a payload bay of device 100. In some embodiments, the payload bay is fixed in place. In some embodiments, the payload bay may be removably coupled to device 100 to facilitate swapping it for another payload bay to quickly reconfigure device 100 with various different payloads.

Example External Views of a Device which Moves About and/or Operates in Relation to a Pile of Granular Material

FIGS. 4A-1, 4A-2, and 4A-3 illustrate front elevational views of the exterior of a device 100 which moves about and/or operates in relation to a pile of granular material, in accordance with various embodiments.

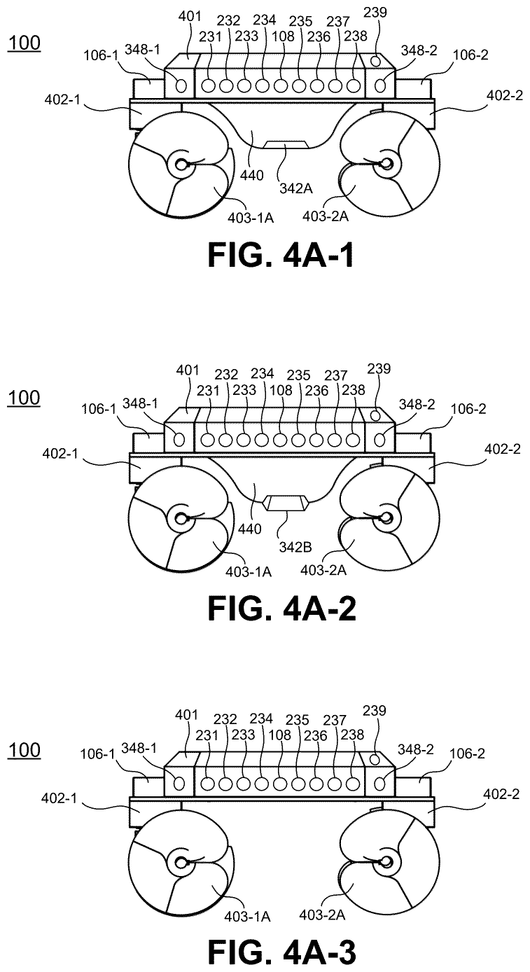

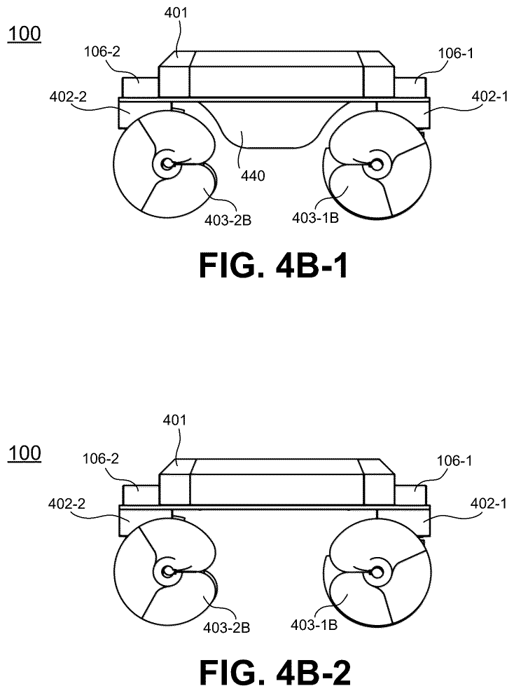

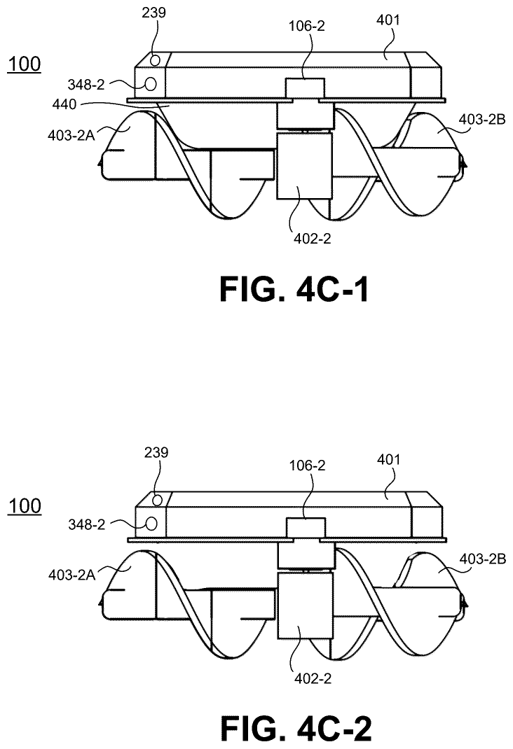

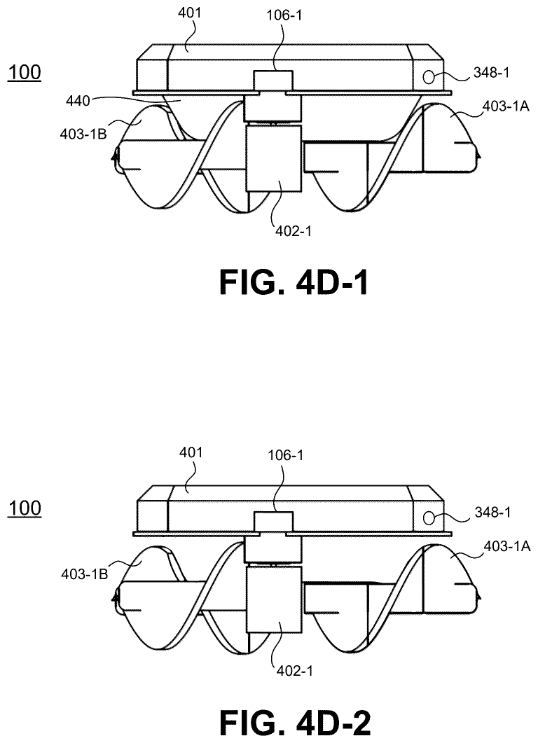

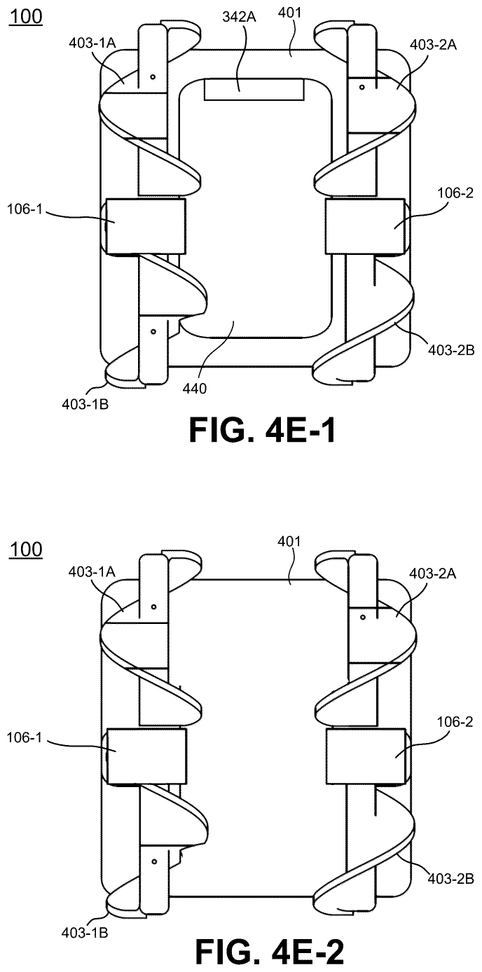

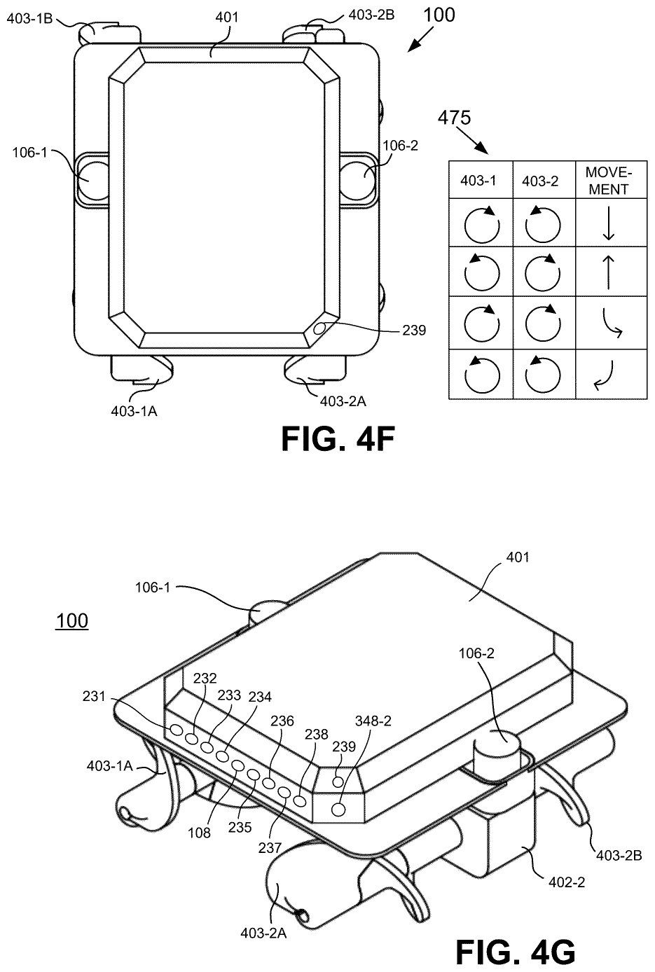

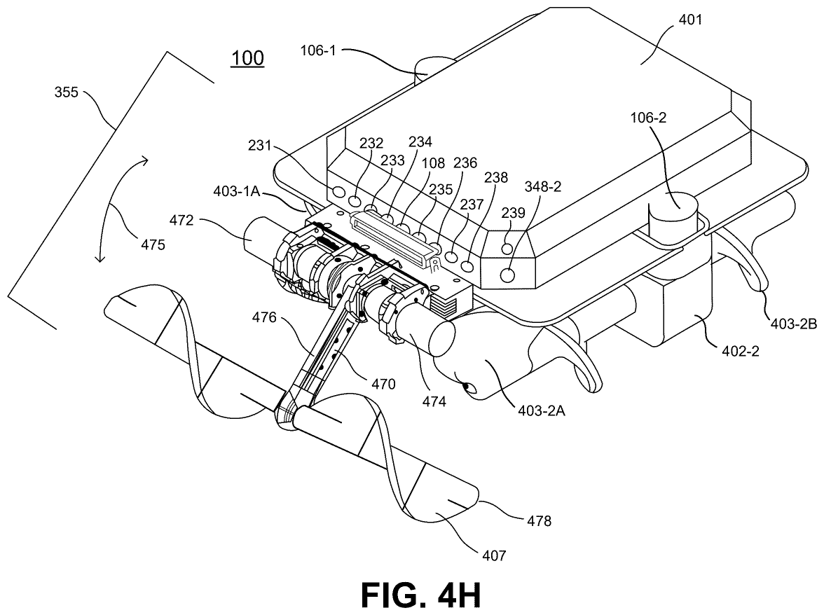

With reference to FIG. 4A-1, device 100 includes a body 401, motors 106 (106-1 and 106-2), transmissions 402 (402-1 and 402-2), and augers 403 (403-1 and 403-2). In the illustrated embodiment of device 100, a pair of augers 403 is utilized. As depicted, the augers 403 are bilateral, however other arrangements of the augers of the drive system are possible and anticipated. In some embodiments, a drive motor 106 may be coupled to an auger 403 (such as to the end of an auger 403) in a manner that eliminates the need of a transmission 402 between the drive motor 106 and the auger 403. In the depicted embodiments, the transmission is located near the middle of each auger 403, thus bifurcating each auger into two portions. In FIG. 4A-1, the front portion 403-1A of auger 403-1 is visible, as is the front portion 403-2A of auger 403-2. In typical operation, augers 403 sink at least partially into the piled granular material and thrust against it as they rotate. The direction and speed of rotation of the augers 403 determines the movement fore, aft, left, right, turning left, and/or turning right of device 100. In this manner, in various embodiments, device 100 can move atop a pile of granular material, can move beneath a pile of granular material (i.e., submerged in it), and can move to the surface after being submerged in a pile of granular material. It should be appreciated that in some embodiments, a different arrangement of augers in an auger-based drive system may be utilized. For example, a different arrangement may not have bilateral augers or else may have one or more augers in addition to bilateral augers. There may be three-parallel augers (like a trimaran hull arrangement in a boat), or augers arranged in parallel with each of the four sides of the robot. Additionally, in a similar arrangement to what is shown, there may be four independent augers, in an embodiment where augers 403-1A, 403-1B, 403-2A, and 403-2B are independently driven (i.e., each with its own motor, motor controller, transmission, etc.).

In some embodiments, device 100 includes one or more payloads 140. For example, lights payloads 348 (348-1 and 348-2) are included to provide illumination. In some embodiments, device 100 may additionally or alternatively include a payload bay 440 which may be fixed to device 100 or removably couplable with device 100. The payload bay 440 may provide a housing for one or more of the payloads 140 discussed herein and/or for other payloads. As one example, payload bay 440 may include sample gatherer payload 342 (show in the closed, non-sample gathering position as 342A). In some embodiments, one or more cameras 108 are included and coupled with body 401. In some embodiments, one or more sensors 120 are included and coupled with body 401 in a manner which provides access to the external environment of device 100. For example, one or more of ultrasonic transducer 231, LIDAR 232, temperature sensor 233, moisture sensor 234, optical sensor 235, infrared sensor 236, electrostatic sensor 237, and electrochemical sensor 238 may be included in a manner which provides sensor access to the operating environment of device 100.

Referring now to FIG. 4A-2, device 100 is illustrated with sample gatherer payload 342 in an open, sample gathering position 342B, to scoop up a sample of granular material as device 100 moves forward with sample gatherer payload open and submerged into the piled granular material upon which device 100 operates.

Referring now to FIG. 4A-3, device 100 is illustrated without payload bay 440. This illustrates a configuration of device 100 in which payload bay 440 has been removed or else device 100 is not configured to support a payload bay 440.

FIGS. 4B-1 and 4B-2 illustrate rear elevational views of the exterior of a device 100 which moves about and/or operates in relation to a pile of granular material, in accordance with various embodiments.

With reference to FIG. 4B-1, the rear portion 403-1B of auger 403-1 is visible, as is the rear portion 403-2B of auger 403-2.

With reference to FIG. 4B-2, device 100 is illustrated without payload bay 440. This illustrates a configuration of device 100 in which payload bay 440 has been removed or else device 100 is not configured to support a payload bay 440.

FIGS. 4C-1 and 4C-2 illustrate right elevational views of the exterior of a device 100 which moves about and/or operates in relation to a pile of granular material, in accordance with various embodiments.

With reference to FIG. 4C-1, the full span of auger 403-2 is visible, including front portion 403-2A and rear portion 403-2B, as is the drive motor 106-2 and transmission 402-2 which, together, operate to drive auger 403-2. An auger-based drive system includes, for example, drive motors 106 and augers 403, and may include transmissions 402. In some embodiments, motor controllers 105 may also be considered a portion of an auger-based drive system. This lateral side of the auger-based drive system of device 100 comprises drive motor 106-2, transmission 402-2, and auger 403-2. As has been discussed, other embodiments may directly drive the auger with the drive motor, thus eliminating the transmission from the auger-based drive system.

With reference to FIG. 4C-2, device 100 is illustrated without payload bay 440. This illustrates a configuration of device 100 in which payload bay 440 has been removed or else device 100 is not configured to support a payload bay 440.

FIGS. 4D-1 and 4D-2 illustrate left elevational views of the exterior of a device 100 which moves about and/or operates in relation to a pile of granular material, in accordance with various embodiments.

With reference to FIG. 4D-1, the full span of auger 403-1 is visible, including front portion 403-1A and rear portion 403-1B, as is the drive motor 106-1 and transmission 402-1 which drives auger 403-1. This lateral side of the auger-based drive system of device 100 comprises drive motor 106-1, transmission 402-1, and auger 403-1. As has been discussed, other embodiments may directly drive the auger with the drive motor, thus eliminating the transmission from the auger-based drive system.

With reference to FIG. 4D-2, device 100 is illustrated without payload bay 440. This illustrates a configuration of device 100 in which payload bay 440 has been removed or else device 100 is not configured to support a payload bay 440.

FIGS. 4E-1 and 4E-2 illustrate bottom plan views of the exterior of a device 100 which moves about and/or operates in relation to a pile of granular material, in accordance with various embodiments.

With reference to FIG. 4E-1 a bottom plan view of device 100 is shown with a payload bay 440 coupled with device 100. As can be seen in FIG. 4E-1, drive auger 403-1 and drive auger 403-2 are arranged in a bilateral fashion and have flighting wound in opposite directions from each other. Thus, the bilateral driver augers 403-1 and 403-2 may be referred to as “opposing screw” drive augers. Propulsion is through direct interaction with the granular material in which device 100 operates and can be forward, reverse, sideways, and turning.

With reference to FIG. 4E-2, device 100 is illustrated in bottom plan view without payload bay 440. This illustrates a configuration of device 100 in which payload bay 440 has been removed or else device 100 is not configured to support a payload bay 440.

FIG. 4F illustrates a top plan view of the exterior of a device 100 which moves about and/or operates in relation to a pile of granular material along with a chart 475 illustrating directional movements, in accordance with various embodiments. Chart 475 shows some examples of rotations of augers 403-1 and 403-2 utilized to implement movement of device 100 in the directions indicated by the arrows in the chart. The rotations and movement directions in chart 475 are in relation to the view of device 100 shown in FIG. 4F. Although not depicted, in some embodiments, device 100 may be operated to move laterally to one side or the other.

FIG. 4G illustrates an upper front right perspective view of the exterior of a device 100 which moves about and/or operates in relation to a pile of granular material, in accordance with various embodiments.

FIG. 4H illustrates an upper front right perspective view of the exterior of a device 100 which moves about and/or operates in relation to a pile of granular material, and which includes a separate auger payload 355, in accordance with various embodiments. In the illustrated embodiment, auger payload 355 is an articulable (up/down 475) rotary auger implement that is mounted to an exterior portion of the body 401 of robot 100. In some embodiments, auger payload 355 may be configured to be fixed in place rather than be articulable up and down. In some embodiments, an electrical and/or communicative coupling may conduct electrical power and/or control signals from within body 401 to power and/or control operation/movement of an attached payload implement 140 such as auger payload 355. For example, such control signals may raise or lower auger payload 355 along arc 475, start/stop the rotation of auger 407, control the direction of rotation of auger 407, and/or control the speed of rotation of auger 407.

Auger payload 355, as depicted, is configured with a rotatable auger component 407 which may be raised or lowered with lift arm 470. Lift arm 470 is actuated along an arced up/down path 475 by electric motor 472. Electric motor 474 spins a pulley (not visible) attached to a belt 476 disposed along the outside edge of lift arm 470. Belt 476 then spins the shaft 478 of auger 407, which is coupled with lift arm 470. As the shaft 478 spins, so does auger 407.

Auger payload 355 may also interchangeably be referred to as auger implement 355, as it serves as a tool for performing work in conjunction with device 100. For example, auger payload 355 may be employed, as an implement, by robot 100 for tasks such as moving material in the path of traversal of robot 100. Auger payload 355 may also be employed, as an implement, by robot 100 to erode a segment near the base of a vertical projection (e.g., a cliff or pillar). Auger payload 355 may also be used, as an implement, by robot 100 to break up chunks and/or crusts of granular material that exist on a surface which is traversed by robot 100.

Though auger payload 355 is separate from the auger based drive system of robot 100, in some embodiments, auger payload 355 may be employed as an auxiliary portion of the auger-based drive system of robot 100 which also includes augers 403. For example, auger 407 of auger implement/payload 355 may be utilized to provide additional thrust or propulsion in a particular direction of travel of robot/device 100.

FIG. 4I illustrates an upper front right perspective view of the exterior of a device 100 which moves about and/or operates in relation to a pile of granular material, and which includes a separate broom payload 350, in accordance with various embodiments. In the illustrated embodiment, broom payload 350 is an articulable (up/down 475) rotary broom implement mounted to an exterior portion of the body 401 of robot 100. In some embodiments, broom payload 350 may be configured to be fixed in place rather than be articulable up and down. In some embodiments, an electrical and/or communicative coupling may conduct electrical power and/or control signals from within body 401 to power and/or control operation/movement of an attached payload implement 140 such as broom payload 350. For example, such control signals may raise or lower broom payload 350 along arc 475, start/stop the rotation of broom 408, control the direction of rotation of broom 408, and/or control the speed of rotation of broom 408.

Broom payload 350, as depicted, is configured with a rotatable broom 408 which may be raised or lowered with lift arm 470. Broom 408 may use blades, bristles or other sweeping components. Lift arm 470 is actuated along an arced up/down path 475 by electric motor 472. Electric motor 474 spins a pulley (not visible) attached to a belt 476 disposed along the outside edge of lift arm 470. Belt 476 then spins the shaft 479 of broom 408, which is coupled with lift arm 470. As shaft 479 spins, so does broom 408.

Broom 350 may also interchangeably be referred to as broom implement 350, as it serves as a tool for performing work in conjunction with device 100. For example, broom payload 350 may be employed for tasks such as moving granular material in the path of traversal of robot 100. Broom payload 350 may also be employed to erode a segment near the base of a vertical projection (e.g., a cliff or pillar).

### Example Systems

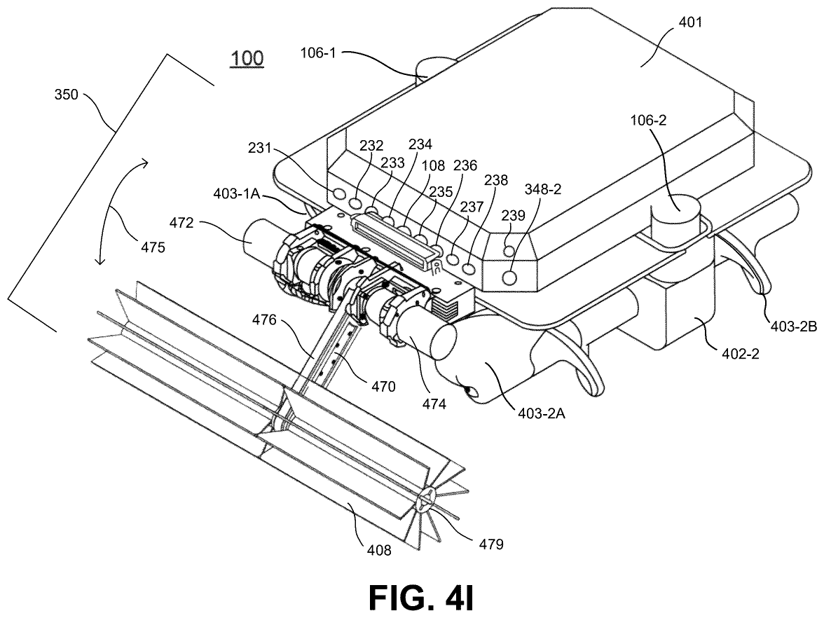

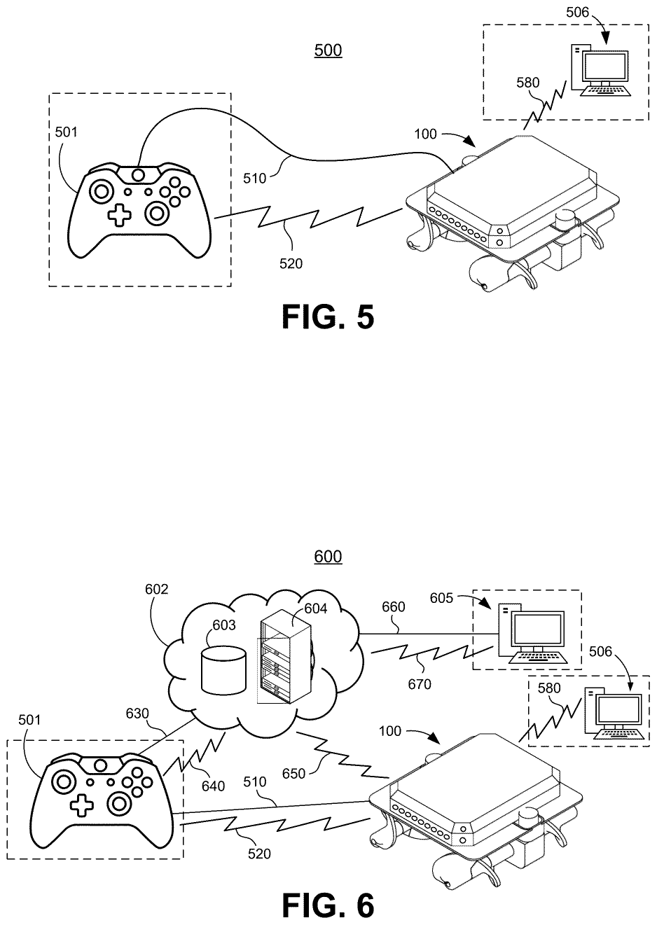

FIG. 5 illustrates some example embodiments of a bulk store slope adjustment system 500, in accordance with various embodiments. System 500 includes at least device 100 when operating autonomously. In some embodiments, system 500 may include device 100 and a remotely located remote controller 501 which is communicatively coupled by wireline 510 or wirelessly 520 with device 100 (e.g., to interface 104) to send instructions or data and/or to receive information or data collected by device 100 (e.g., from operation of device 100 and/or from sensor(s) 120 and/or payload(s) 140). Remote controller 501 may be like a handholdable remote controller for a video game, or a remotely controlled model car or model airplane. In some embodiments, remote controller may have a display screen for visual display of textual information or still/video images received from device 100. In some embodiments, remote controller 501 is utilized by an operator to maneuver device 100 and/or to operate sensor(s) 120 and/or payload(s) 140. In some embodiments, system 500 may include device 100 and a remotely located computer system 506 which is communicatively coupled wirelessly 580 with device 100 to send instructions or data and/or to receive/access information or data collected by device 100 (e.g., from operation of device 100 and/or from sensor(s) 120 and/or payload(s) 140). In some embodiments, system 500 may include device 100 along with a communicatively coupled remote controller 501 and a communicatively coupled remotely located computer system 506. It should be appreciated that wireless communications 520 and 580 may be peer-to-peer, over a wide area network, or by other protocols.

FIG. 6 illustrates some example embodiments of a bulk store slope adjustment system 600, in accordance with various embodiments. In some embodiments, system 600 includes device 100 in wireless communicative coupling 650 (e.g., via the Internet) with one or more of cloud-based 602 storage 603 processing 604. In some embodiments, cloud-based 602 storage 603 is used to store data collected by device 100. In some embodiments, cloud-based processing 604 is used to process data collected by device 100 and/or to assist in autonomous decision making based on collected day. In some embodiments, system 600 additionally includes a remotely located computer 605, communicatively coupled to cloud 602 (e.g., via the internet) either wirelessly 670 or by wireline 660. In this fashion, remotely located computer 605 may access data from device 100 which has been uploaded to storage 603 and/or may communicate with or access device 100 by relay through processing/computer system 605 or cloud 602. In some embodiments, system 600 may additionally include one or more components (remote controller 501 and/or remotely located computer system 506) which were described in FIG. 5. In some embodiments, one or more of remote controller 501 and remote computer system 506 may be communicatively coupled (e.g., 630/640) with cloud 602 for transmission and/or receipt of information related to device 100.

### Section 2

### Example Bulk Store and Example Operations to Adjust Slope of a Portion of Piled Granular Material

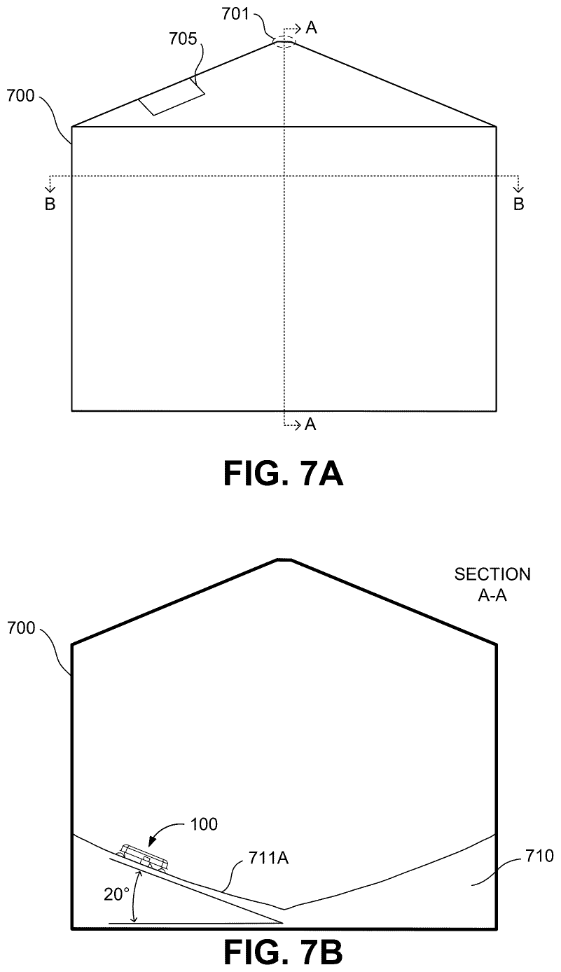

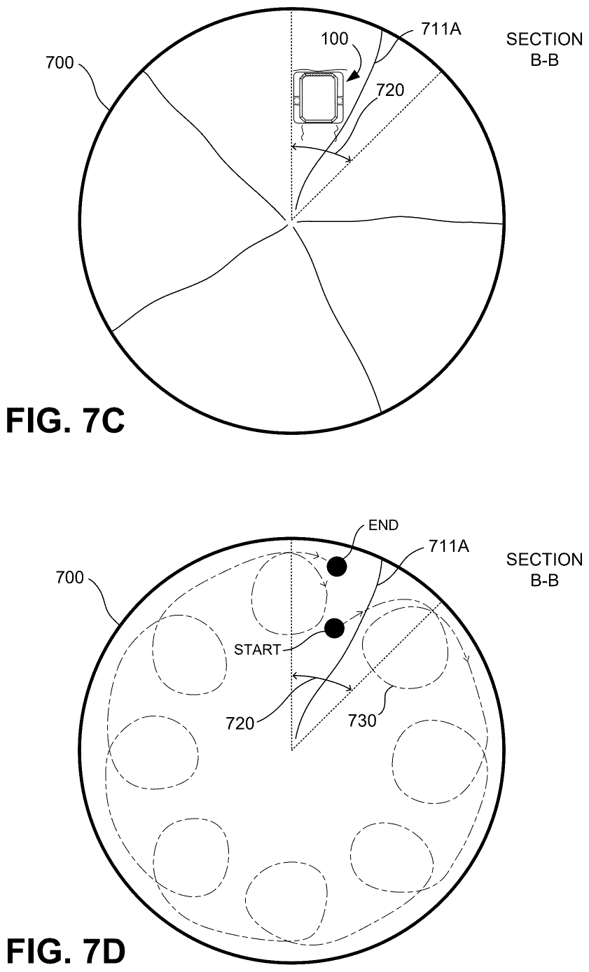

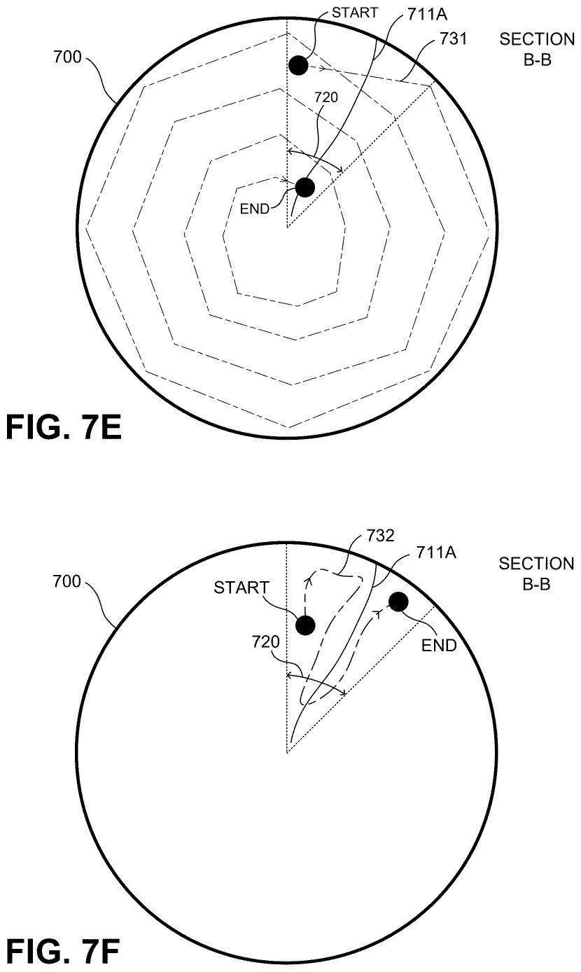

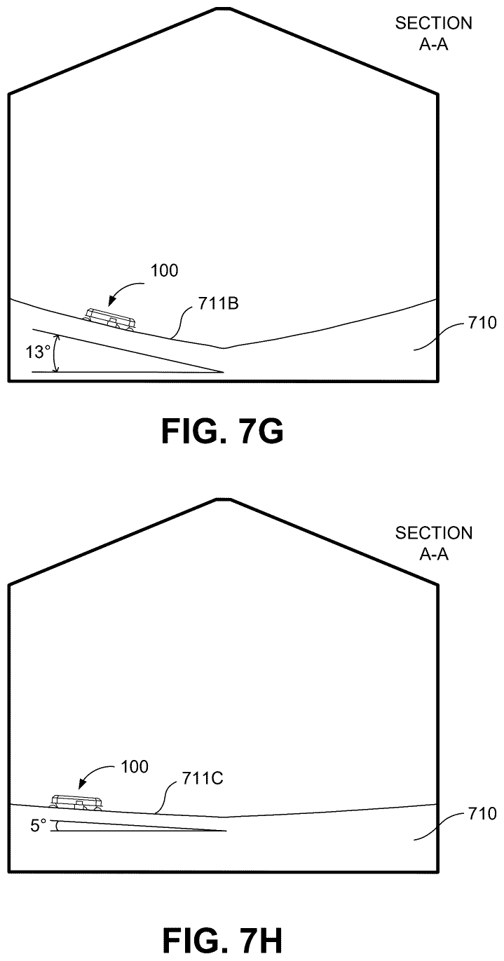

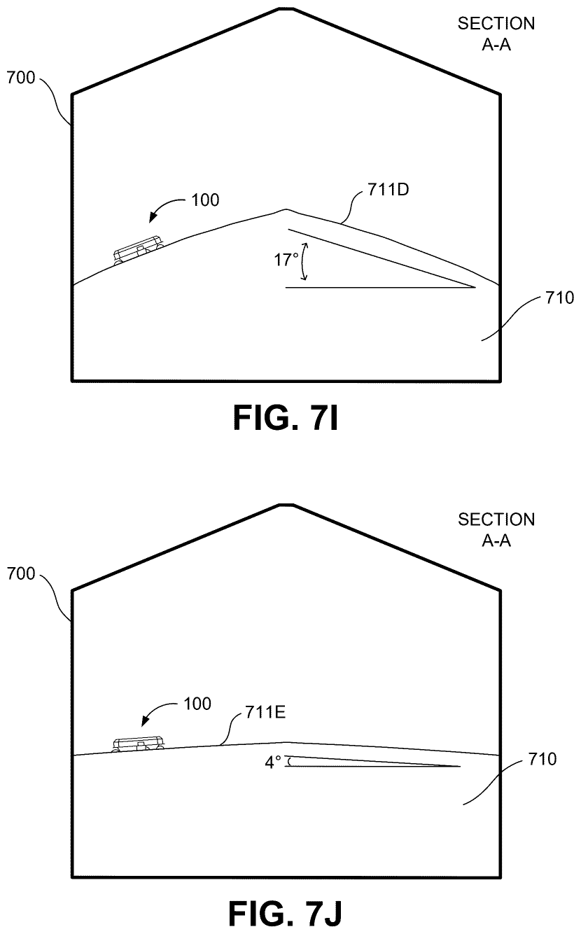

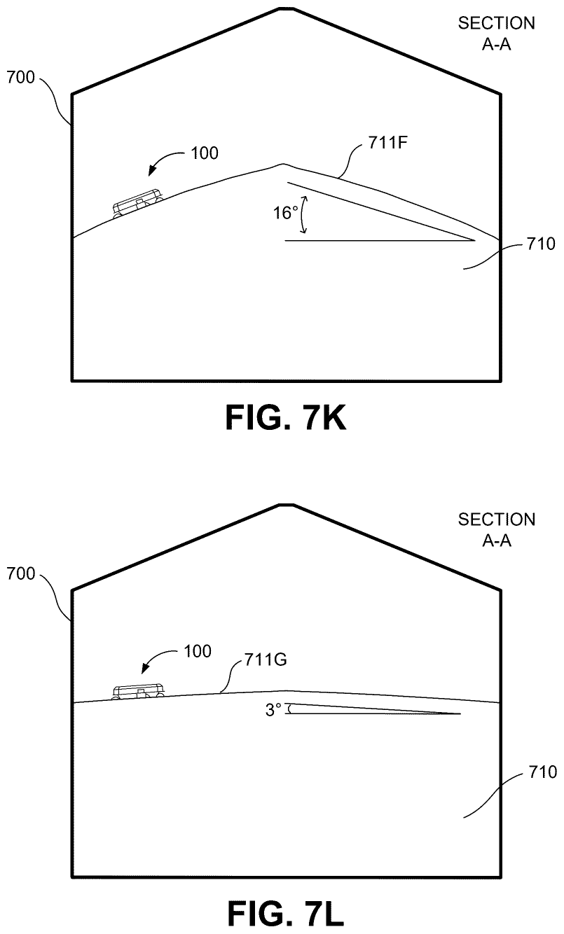

FIG. 7A illustrates an example bulk store 700 for granular material, in accordance with various embodiments. For purposes of example, and not limitation, bulk store 700 is depicted as a grain bin which is used to bulk store grain (e.g., edible seeds/beans such as corn, wheat, soybeans, peas, rice, beans, etc.). However, in other embodiments, bulk store 700 may store other granular materials. Bulk store 700 includes an access door 705 through which device 100 may be inserted into and/or removed from bulk store 700. Bulk store 700 also includes a top loading portal 701 through which bulk grain or other granular material may be filled into bulk store 700, by an auger or other filling system (not depicted in FIG. 7), and then fall into bulk store 700 to form a pile of granular material (e.g., grain 710 shown in FIG. 7B). Section lines depict a location and a direction of Section A-A and Section B-B which will be illustrated in other figures.

FIG. 7B illustrates a side sectional view A-A of an example bulk store 700 for granular material which shows a device 100 moving about and/or operating in relation to a portion (portion 720 as shown in FIG. 7C) of piled granular material (e.g., grain 710) in the bulk store 700, in accordance with various embodiments. Because some of grain 710 has been removed from the bottom of bulk store 700, a cone shaped concavity on surface 711A has been created with a slope of approximately 20 degrees down from the walls to the center of bulk store 700 in the portion of piled granular material where device 100 is operating. The slope of 20 degrees is used for example purposes only. The maximum angle of the downward slope from the sides to the middle (or from the middle to the sides) is dictated by the angle of repose, which differs for different granular materials and may differ for a particular granular material based on environmental physical characteristics (such as moisture) of the granular material. When a granular material is steeply sloped and near the angle of repose, it can be easily triggered to slide and cause entrapment of a person. When the slope of a granular material exceeds its angle of repose, it slides (like an avalanche). Additionally, when a surface 711A of grain 710 becomes steeply sloped toward the center (as illustrated) during removal of grain 710 from bulk store 700, it means that much of the removed grain is coming out from the center of the bin, rather than a mixture of grain from all areas of the bin. Leveling, or reduction of slope, of an inwardly sloped pile, reduces risk of a slide from a steeply sloped surface 711A and distributes grain from the high sloped edges to prevent/reduce spoilage of those portions of the grain.

Due to the friction of augers 403 against grain 710 and the agitation of augers 403 caused to grain 710 when device 100 traverses a portion of piled granular material (e.g., portion 720 of grain 710), viscosity of the piled granular material at or near surface 711A is disrupted. The disruption of viscosity lowers the angle of repose and, because of the slope being caused to exceed the angle of repose, incites sediment gravity flow in the portion of piled granular material down the slope. Additionally, rotational movement of the augers also displaces grain 710 and can be used to auger the grain in a desired direction or expel it such that gravity carries it down slope. Either or both of these actions can be used to disperse grain 710 and/or to adjust (reduce) the slope of the surface 711A of portion 720 and other similar portions.

FIG. 7C illustrates a top sectional view B-B of an example bulk store 700 for granular material which shows a device 100 moving about and/or operating on surface 711A in relation to a portion 720 of piled granular material 710 in the bulk store 700, in accordance with various embodiments.

FIG. 7D illustrates a top sectional view B-B of an example bulk store 700 for granular material which shows pattern 730 for moving a device 100 about and/or operating on surface 711A in relation to surface a portion 720 of piled granular material 710 in the bulk store 700, in accordance with various embodiments. In some embodiments, pattern 730 may be manually driven by a remotely located operator via remote controller 501 (for example). In some embodiments, pattern 730 may be autonomously driven by device 100. In some embodiments, pattern 730 may be initiated due to a first measurement of the angle of slope of the surface 711A of grain 710 in portion 720 satisfying a first condition such as being beyond an acceptable threshold angle (e.g., 10 degrees of slope). Pattern 730 or other patterns of traversal of portion 720 may be repeatedly driven until a follow-on measurement of the angle of slope of grain 710 in portion 720 meets a second condition (e.g., falls below the threshold angle or falls below some other angle such as 7 degrees). In this manner a portion (e.g., portion 720) or all of the grain in bulk store 700 can have its slope adjusted downward, closer to level.

FIG. 7E illustrates a top sectional view B-B of an example bulk store 700 for granular material which shows pattern 731 for moving a device 100 about and/or operating on surface 711A in relation to a portion 720 of piled granular material 710 in the bulk store 700, in accordance with various embodiments. In some embodiments, pattern 731 may be manually driven by a remotely located operator via remote controller 501 (for example). In some embodiments, pattern 731 may be autonomously driven by device 100. In some embodiments, pattern 731 may be initiated due to a first measurement of the angle of slope of surface 711A of grain 710 in portion 720 satisfying a first condition such as being beyond an acceptable threshold angle (e.g., 10 degrees of slope). Pattern 731 or other pattern(s) of traversal of portion 720 may be repeatedly driven until a follow-on measurement of the angle of slope of surface 711A of grain 710 in portion 720 meets a second condition (e.g., falls below the threshold angle or falls below some other angle such as 7 degrees). In this manner a portion (e.g., portion 720) or all of the grain in bulk store 700 can have its surface slope adjusted downward, closer to level.

FIG. 7F illustrates a top sectional view B-B of an example bulk store 700 for granular material which shows pattern 732 for moving a device 100 about and/or operating on surface 711A in relation to a portion 720 of piled granular material 710 in the bulk store 700, in accordance with various embodiments. In some embodiments, pattern 732 may be manually driven by a remotely located operator via remote controller 501 (for example). In some embodiments, pattern 732 may be autonomously driven by device 100. In some embodiments, pattern 732 may be initiated due to a first measurement of the angle of slope of surface 711A of grain 710 in portion 720 satisfying a first condition such as being beyond an acceptable threshold angle (e.g., 10 degrees of slope). Pattern 732 or other pattern(s) of traversal of portion 720 may be repeatedly driven until a follow-on measurement of the angle of slope of surface 711A of grain 710 in portion 720 meets a second condition (e.g., falls below the threshold angle or falls below some other angle such as 7 degrees). In this manner a portion (e.g., portion 720) or all of the grain in bulk store 700 can have its surface slope adjusted downward, closer to level. In FIG. 7F, pattern 732 is confined to portion 720. In such an embodiment, only this portion may be leveled by device 100, or else device 100 may work its way around bulk store 700 portion by portion by portion, leveling surface 711A in each portion completely or incrementally before moving to the next portion.

FIGS. 7D-7F illustrate only three example patterns, many other patterns are possible and anticipated including, but not limited to: grid patterns, circular patterns, symmetric patterns, unsymmetrical patterns, spiral patterns, random/chaos motion (e.g., patternless), patterns/paths that are dynamically determined based on the slope and changes of the slope, and patterns which are cooperatively executed by two or more devices 100 working in communication with one another. Any of the patterns executed by device 100 may be stored in host memory 103 for automated execution by processor 102 controlling the movements of device 100 to traverse the pattern. Similarly, patternless or dynamic movement may be executed by processor 102 in an automated fashion by controlling the movements of device 100, such as to seek out portions with a slope which satisfies a first condition and traverse them until the slope satisfies the second condition.

In some embodiments, patterns or traversal operations may similarly be utilized to break up and distribute grain 710 to assist it in drying out, to prevent a crust from forming, to inspect grain, to push grain towards a sweep auger or other uptake, and/or to diminish spoilage.

In some embodiments, patterns or traversal operations may similarly be utilized to level peaks which form in grain or other piled granular material due to the method and/or location in which it is loaded into a bulk store. Such leveling better utilizes available storage space, reduces crusts or pipe formation, reduces hotspots, and/or more evenly distributes granular material of differing moisture contents.

FIG. 7G illustrates a side sectional view A-A of an example bulk store 700 for granular material 710 which shows a device 100 moving about and/or operating in relation to one or more portions (e.g., portion 720 and the like) on the surface 711B of piled granular material 710 in the bulk store 700, in accordance with various embodiments. FIG. 7G is similar to FIG. 7B except that the slope of the upper surface 711B has been downwardly adjusted from 20 degrees of surface 711A to approximately 13 degrees (as measured by device 100 or other means) by traversal of the surface by device 100 in the manner previously described to effect surface leveling and slope adjustment (i.e., traversed in a “leveling traversal”). In an embodiment where this 13-degree slope is below a predetermined threshold, leveling and slope adjustment operations may cease. In an embodiment where this 13-degree slope is above a predetermined threshold, leveling and slope adjustment operations may continue toward achieving a slope threshold which is closer to 0 degrees.

FIG. 7H illustrates a side sectional view A-A of an example bulk store 700 for granular material 710 which shows a device 100 moving about and/or operating in relation to a one or more portions (e.g., portion 720 and the like) on the surface 711C of piled granular material 710 in the bulk store 700, in accordance with various embodiments. FIG. 7H is similar to FIG. 7G except that the slope of the upper surface 711C has been further downwardly adjusted from 13 degrees of surface 711B to approximately 5 degrees (as measured by device 100 or other means) by traversal of the surface by device 100 in the manner previously described to effect surface leveling and slope adjustment (i.e., traversed in a “leveling traversal”). In an embodiment where this 5-degree slope is below a predetermined threshold, leveling and slope adjustment operations may cease. In an embodiment where this 5-degree slope is above a predetermined threshold, leveling operations may continue toward achieving a slope threshold which is closer to 0 degrees.

FIG. 7I illustrates a side sectional view A-A of an example bulk store 700 for granular material 710 which shows a device 100 moving about and/or operating in relation to one or more portions (e.g., portion 720 and the like) on the surface 711D of piled granular material 710 in the bulk store 700, in accordance with various embodiments. FIG. 7I differs from FIGS. 7B, 7G, and 7H, in that the slope of surface 711D of grain 710 is now peaked in the middle and low on the edges, sloping downward at about 17 degrees from the center due to filling of additional grain 710 atop surface 711C of FIG. 7H via centrally located top loading portal 701 (see e.g., FIG. 7A). In some embodiments, device 100 can operate in the same manner to level grain 710 during and/or after completion of the fill operation.

FIG. 7J illustrates a side sectional view A-A of an example bulk store 700 for granular material 710 which shows a device 100 moving about and/or operating in relation to a one or more portions (e.g., portion 720 and the like) on the surface 711E of piled granular material 710 in the bulk store 700, in accordance with various embodiments. FIG. 7J is similar to FIG. 7I except that the slope of the upper surface 711E has been downwardly adjusted from 17 degrees of surface 711D to approximately 4 degrees (as measured by device 100 or other means) by traversal of the surface by device 100 in the previously manner for surface leveling and slope adjustment (i.e., traversed in a “leveling traversal”). In an embodiment where this 4-degree slope is below a predetermined threshold, leveling and slope adjustment operations may cease. In an embodiment where this 4-degree slope is above a predetermined threshold, leveling operations may continue toward achieving a slope threshold which is closer to 0 degrees.

FIG. 7K illustrates a side sectional view A-A of an example bulk store 700 for granular material 710 which shows a device 100 moving about and/or operating in relation to one or more portions (e.g., portion 720 and the like) on the surface 711F of piled granular material 710 in the bulk store 700, in accordance with various embodiments. FIG. 7K illustrates an embodiment where additional grain 710 has been loaded atop the substantially leveled surface 711E of FIG. 7J and is now peaked in the middle and low on the edges, sloping downward at about 16 degrees from the center due to filling of additional grain 710 atop surface 711E of FIG. 7J via centrally located top loading portal 701 (see e.g., FIG. 7A). In some embodiments, device 100 can operate in the same manner to level grain 710 during and/or after completion of the fill operation.

FIG. 7L illustrates a side sectional view A-A of an example bulk store 700 for granular material 710 which shows a device 100 moving about and/or operating in relation to a one or more portions (e.g., portion 720 and the like) on the surface 711G of piled granular material 710 in the bulk store 700, in accordance with various embodiments. FIG. 7L is similar to FIG. 7K except that the slope of the upper surface 711G has been downwardly adjusted from about 16 degrees of surface 711F to approximately 3 degrees (as measured by device 100 or other means) by traversal of the surface by device 100 in the previously manner for surface leveling and slope adjustment (i.e., traversed in a “leveling traversal”). In an embodiment where this 3-degree slope is below a predetermined threshold, leveling and slope adjustment operations may cease. In an embodiment where this 4-degree slope is above a predetermined threshold, leveling operations may continue toward achieving a slope threshold which is closer to 0 degrees.

### Example Method(s) of Bulk Store Slope Adjustment

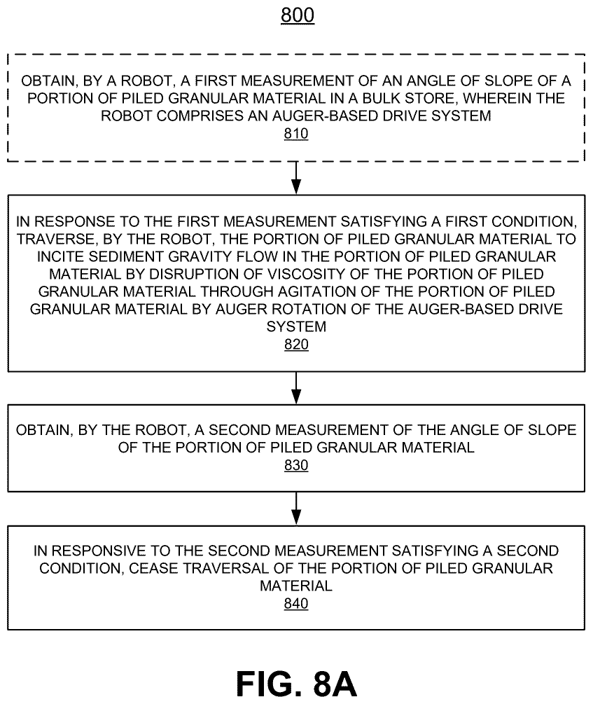

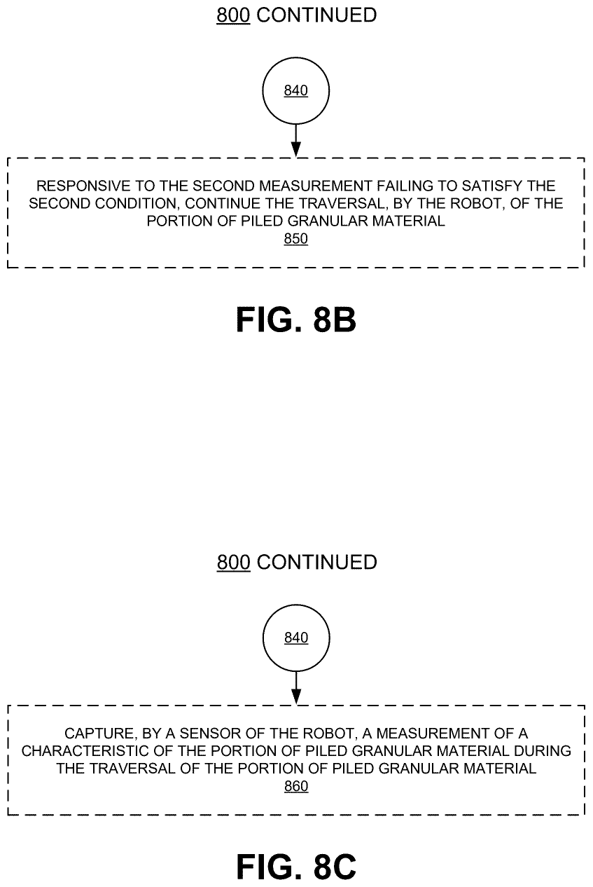

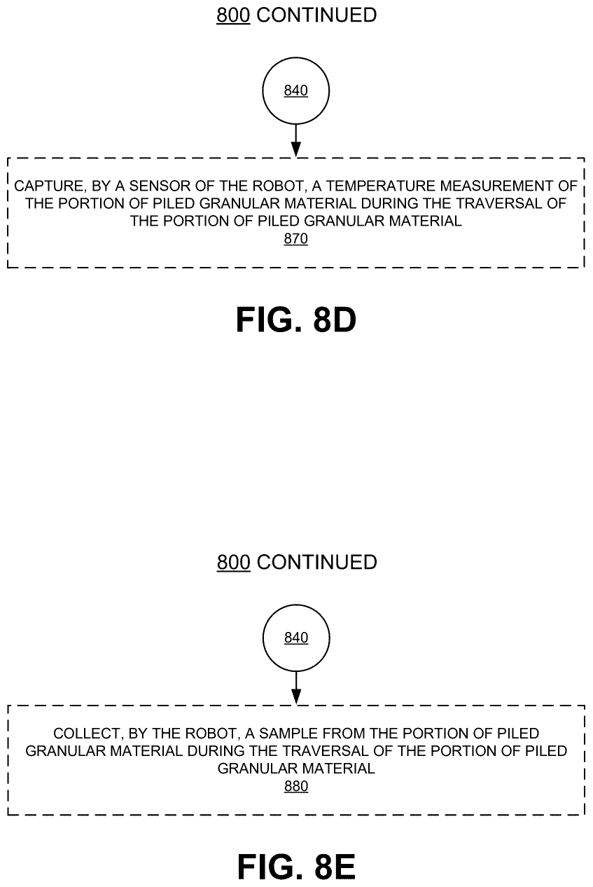

Procedures of the methods illustrated by flow diagram 800 of FIGS. 8A-8E will be described with reference to elements and/or components of one or more of FIGS. 1-7L. It is appreciated that in some embodiments, the procedures may be performed in a different order than described in a flow diagram, that some of the described procedures may not be performed, and/or that one or more additional procedures to those described may be performed. Flow diagram 800 includes some procedures that, in various embodiments, are carried out by one or more processors (e.g., host processor 102 or any processor of device 100 or a computer or system to which device 100 is communicatively coupled) under the control of computer-readable and computer-executable instructions that are stored on non-transitory computer-readable storage media (e.g., host memory 103, other internal memory of device 100, or memory of a computer or system to which device 100 is communicatively coupled). It is further appreciated that one or more procedures described in flow diagram 800 may be implemented in hardware, or a combination of hardware with firmware and/or software.

For purposes of example only, device 100 of FIGS. 1-7L is a robotic device which utilizes augers (403) to move and maneuver with respect to piled granular material, such as, but not limited to grain. Robot 100 will be described as operating on or in relation to piled granular material in a bulk store, such as, but not limited to grain in a grain bin. In some embodiments, the robot 100 is free of mechanical coupling with a structure (e.g., the bulk store) in which the piled granular material is contained. For example, in some embodiments, there is no tether or safety harness coupling the robot 100 to the grain storage bin and it operates autonomously or under wireless remote control. In some embodiments, robot 100 performs the method of flow diagram 800 completely autonomously. In some embodiments, robot 100 performs the method of flow diagram 800 semi-autonomously such as by measuring a slope of grain, sending the slope to an external computer system which then determines a pattern for robot 100 to autonomously execute when traversing the piled grain. In some embodiments, robot 100 performs the method of flow diagram 800 semi-autonomously such as by receiving a remotely measured slope of grain, then autonomously determining a pattern for robot 100 to autonomously execute when traversing the piled grain.

FIGS. 8A-8E illustrate a flow diagram 800 of an example method of bulk store slope adjustment, in accordance with various embodiments.

With reference to FIG. 8A, at procedure 810 of flow diagram 800, in various embodiments, a robot 100 which includes a processor 102, a memory 103, and an auger-based drive system (e.g., augers 403), obtains a first measurement of an angle of slope of a portion of piled granular material in a bulk store, wherein the robot 100 comprises an auger-based drive system. With reference to FIGS. 7A-7L, this can comprise a measure of the angle of slope of the surface 711 of portion 720 of grain 710 in bin 700. The angle can be measured and obtained autonomously by robot 100 or can be measured by a device external to robot 100 and then obtained by being communicated to or accessed by robot 100. In an embodiment, where the angle of slope of surface 711 is measured by robot 100, motion sensor(s) 220 may be used to measure the angle of robot 100 on a slope of portion 720 to approximate the angle of the slope. In some embodiment, procedure 810 may be skipped and an operator may simply direct robot 100 to begin traversal of a portion (e.g., portion 720) of piled granular material.

With continued reference to FIG. 8A, at procedure 820 of flow diagram 800, in various embodiments, in response to the first measurement satisfying a first condition, the robot 100 traverses the portion of piled granular material to incite sediment gravity flow in the portion of piled granular material by disruption of viscosity of the portion of piled granular material through agitation of the portion of piled granular material by auger rotation of the auger-based drive system. The traversal may be controlled by host processor 102 via control of the direction of rotation and/or the speed of rotation of augers 403 of robot 100. Robot 100 may traverse the portion (e.g., portion 720) of the surface 711 of piled granular material (e.g., piled grain 710) in a predetermined pattern, which may be a predetermined pattern of movement stored in host memory 103 of robot 100. Robot 100 may traverse the portion (e.g., portion 720) of piled granular material (e.g., piled grain 710) in a patternless or random/chaos manner or by following dictates other than a pattern such as by dynamically seeking out areas of slope above a certain measure. In some embodiments, a pattern may be changed or altered based on information sensed by robot 100.

With continued reference to FIG. 8A, at procedure 830 of flow diagram 800, in various embodiments, robot 100 obtains a second measurement of the angle of slope of the portion of piled granular material. This second measurement is obtained after the robot has traversed the portion (e.g., portion 720) of surface 711 following a pattern, for a predetermined period of time, or based on other criteria for re-measurement of the slope. The second angle measurement can be measured and obtained autonomously by robot 100 or can be measured by a device external to robot 100 and then obtained by being communicated to or accessed by robot 100.

With continued reference to FIG. 8A, at procedure 840 of flow diagram 800, in various embodiments, in response to the second measurement satisfying a second condition, robot 100 ceases traversal of the portion of piled granular material. In some embodiments, the first condition is related to a first angle and the second condition is related to a second angle.

In some embodiments, where the first angle is the same as the second angle, the first condition may be met when the first measurement exceeds the angle, and the second measurement may be met when the second measurement falls below the angle. For example, the angle may be 10 degrees, and when the first measurement is 20 degrees, traversal will continue until the angle is adjusted to below 10 degrees.

In some embodiments, where the first angle and the second angle are different, the first angle is larger than the second angle. For example, the first angle may be 10 degrees while the second angle is 5 degrees. In such an embodiment, when the first measurement is 20 degrees, traversal will continue until the angle meets the second condition (e.g., drops below 5 degrees).

With reference to FIG. 8B, at procedure 850 of flow diagram 800, in various embodiments, in response to the second measurement failing to satisfy the second condition, robot 100 continues traversal of the portion of piled granular material. For example, if the second condition specifies that the measurement of slope needs to be reduced to below 5 degrees, the robot would continue traversal of the portion of piled granular material in response to the second measurement being 13 degrees.

With reference to FIG. 8C, at procedure 860 of flow diagram 800, in various embodiments, during traversal of the portion (e.g., 720) of piled granular material by robot 100, a sensor 120 of robot 100 acts under instruction of host processor 102 to capture a measurement of a characteristic of the portion of piled grain. Some example characteristics include, but are not limited to, capturing a measurement of: temperature, humidity, moisture, gas composition, electrostatic nature, and/or electrochemical nature. A measured characteristic may also comprise an optical and/or infrared image. The captured measurement of a characteristic can be stored within memory 103 or transmitted from robot 100. In some embodiments, the captured measurement of a characteristic is paired with a location of robot 100 at the time of capture of the measurement. Such paired data can be used to create a characteristic map of the piled granular material which is traversed by robot 100.

In some embodiments, the captured measurement(s) of characteristic(s) may be transmitted to a base station (506, 605) communicatively coupled with robot 100. The base station (506, 605) is located remotely from the robot and may be configured to communicate with robot 100 over the Internet, via a wide-area network, via a peer-to-peer communication, or by other means. Via such communications, the base station (506, 605) may receive data collected by robot 100 (including motion sensor data) collected by the robot during the traversal of the portion of piled granular material. Additionally, or alternatively, via such communications, the base station (506, 605) may relay instructions to robot 100.

In some embodiments, the captured measurement(s) of characteristic(s) may be transmitted to a cloud-based 602 storage 603 and/or processing 604 which is/are communicatively coupled with robot 100. The cloud-based infrastructure 602 may be utilized to process data, store data, make data available to other devices (e.g., computer 605), and/or relay information or instructions from other devices (e.g., computer 605) to robot 100.

With reference to FIG. 8D, at procedure 870 of flow diagram 800, in various embodiments, a temperature sensor 233, infrared sensor 236, or infrared camera 108 of robot 100 is used to capture a temperature measurement of the portion of piled granular material during the traversal of the portion of piled granular material. In some embodiments, the captured measurement of a characteristic is paired with a location of robot 100 at the time of capture of the temperature measurement. Such paired data can be used to create a heat map of the piled granular material which is traversed by robot 100.

The heat map, when implemented, provides a data visualization that shows changes in temperature as changes in surface color or shading relative to the traversed surface or a depiction thereof. It should be appreciated that the heat map type visualization can similarly be used to show changes in other measured data relative to a traversed surface or depiction thereof. In other embodiments, the paired data may can be graphed or mapped spatially such as on a depiction of the traversed surface; and, in some embodiments, the spatially mapped/graphed data is interactive such that a user may click on a point of paired data to show a visualization of the underlying data associated with the paired data (e.g., the measured 3-D location and temperature). It should be such heat maps and spatially mapped/graphed data is formatted, in some embodiments, for display on a computer or monitor display (e.g., the display associated with a controller 501, a computer 506, a computer 605, or the like) to support management of the piled granular material and the bulk store during loading, storage, and/or unloading of the piled granular material. Among other management activities, the collected and visually displayed data may assist a human (e.g., a farmer, worker, bin manager) in controlling hot spots, controlling mold conditions, manipulating grain to reduce spoilage, manipulating grain to reduce formation of grain bridges, manipulating grain to reduce formation to disperse BGFM (e.g., small particles, broken grain, chaff, and the like), manipulating grain to unload grain with desired characteristics (e.g., desired moisture level and/or desired visual exterior surface characteristics such as low cracking), managing or having knowledge of a slope of the piled grain, etc.

With reference to FIG. 8E, at procedure 880 of flow diagram 800, in various embodiments, robot 100 collects a sample from the portion of piled granular material during the traversal of the portion of piled granular material. For example, with reference to FIG. 4A-2, processor 102 or a remotely located operator may direct a sample collection device, such as gatherer payload 342, to open to collect a sample of grain at a particular location and to close after a sample is collected or a predetermined time period has elapsed.

### Mapping Piled Granular Material in a Bulk Store

In various embodiments, for example, device 100 can operate via remote controlled instruction, autonomously, or some combination thereof. Although various embodiments of a device 100 are described herein (e.g., device 100, device 100B), it is referred to generically as device 100. Also, as discussed above, device 100 is robotic and may be referred to as a “robot” (e.g., “robot 100”) or as a “robotic device,” (e.g., “robotic device 100”) or the like. Device 100 includes an auger-based drive system which facilitates the movement and/or operation of device 100 in relation to a portion of piled granular material (e.g., grain) in a bulk store 700, such as a grain bin.

A device 100 may record its location in three dimensions as it traverses a surface 711 of a piled granular material 710 in a bulk store 700. For example, three-dimensional positions may be recorded during any traversal, such a random traversal, a traversal in a pattern such as the example patterns illustrated in FIGS. 7D-7F, or during a pattern executed purposefully for mapping or surface management, during slope adjustment, during maintenance traversals, during traversals to break up a crust, and during traversals to remove vertical projections. The positions may be stored and later or on-the-fly assembled into a three-dimensional map of the surface 711 of the piled granular material 710 (e.g., grain). The assembly of the map may be performed by device 100, or the positions may be communicatively coupled such as by wireless communication to an external computer system 506 located remotely from the device. The external computer system 506 may then assemble the recorded locations into a three-dimensional map of the surface 711 of the piled granular material 710 (e.g., grain).

Positions of device 100 may be acquired by any suitable means, including but not limited to: differential Global Navigation Satellite System (GNSS) positioning, real-time kinematic GNSS positioning, triangulation from at least two known points marked inside and/or outside the bulk store 700 (e.g., by optically, sonically, ultrasonically, or via radio signals measuring angle and distance to the known points); using motion sensors 220 and additionally a barometric sensor 239 (in some embodiments) as an internal inertial measurement unit (IMU) to navigate from a known starting location; and receiving a position communicated (wirelessly) from an external source such as a camera or laser measuring device mounted to the internal roof or upper wall of a bulk store (e.g., bulk store 700). In various embodiments, more than one positioning means may be used.

The three-dimensional map may be assembled by plotting the recorded locations, such as on a three-dimensional graph with X, Y, and Z axis. This three-dimensional map may be viewed in any desired orientation or view and may be overlaid on a depiction of the bulk store 700 in which the assembled positions were recorded. In some embodiments, the three-dimensional map may be used to determine how much, if any, leveling needs to be performed on a surface 711 of a piled granular material 710. In some embodiments, when coupled with a known location of a bottom surface of a bulk store 700 (such as a grain bin), the volume between the mapped three-dimensional surface 711 (e.g., a surface contour map) and the bottom of the bulk store 700 may be calculated by device 100 or the external computer system 506.

Additionally, during any traversal of piled granular material 710, device 100 may capture one or more environmental characteristics with its sensors (e.g., temperature (with temperature sensor 233), humidity (e.g., with humidity sensor 242), moisture (e.g., directly with moisture sensor 234 or indirectly via calculation from measured temperature and humidity), amount of carbon dioxide (e.g., with carbon dioxide sensor 241), a measurement of atmospheric pressure (e.g., with barometric sensor 239), an optical image (e.g., with optical sensor/camera 235) to record visible environmental conditions, and an infrared image (e.g., with infrared sensor/camera 236), among others. For example, one or more sensors 120 of device 100 may capture measurements of environmental characteristics relative to the piled granular material being traversed by device 100. In some embodiments, such measurements may be taken at locations that are specified by coordinates with respect to the bulk store 700. In some embodiments, such measurements may be taken at intervals of time passed and/or distance traveled. In an example of time separated measurement intervals, an environmental measurement may be taken by one or more of the sensors 120 every 5 seconds, every 10 seconds, or more than once per second (e.g., 2, 3, or 10 times per second) as device 100 traverses. In an example of distance separated measurement intervals, an environmental measurement may be taken by one or more of the sensors 120 each time device 100 has moved a specified distance from a previous location (e.g., every centimeter of travel, every 5 centimeters of travel, every 10 centimeters of travel, every meter of travel, etc.). In some embodiments, the time and/or three-dimensional location of an environmental measurement captured by a sensor 120 is/are noted and stored in conjunction with captured environmental characteristics.

In some embodiments, device 100 may assemble the captured environmental characteristic(s) onto the three-dimensional surface map of the surface 711 of a piled granular material 710. In other embodiments, device 100 may communicatively couple (e.g., by wireless communication) the environmental characteristics and their respective three-dimensional locations and/or times of capture to external computer system 506 which then assembles them onto the three-dimensional surface map of the surface 711 of a piled granular material 710.

In some embodiments, multiple three-dimensional maps may be made over time, such as during filling or withdrawal of piled granular material 710 from the bulk store 700. These maps may be combined to form a three-dimensional map of the captured environmental characteristics of the piled granular material 710. The assembly of multiple surface maps in this manner may be accomplished by device 100 or computer system 506, or other computing system which is supplied with the captured environmental characteristics and respective three-dimensional locations of capture.

A device 100 may operate as an assistant in the management of grain that is stored in a bulk store. By way of example, and not of limitation, the grain may be stored within a grain bin and the device 100 may operate to assist with management of a grain bin: prior to load-in of grain, during load-in of grain, after load-in of grain, during long term storage of grain, during extraction of grain, and/or during final clean-out of grain from a bin. The management may be a primary role of device 100 or as an extension of a device 100 traversing the surface of piled granular material for leveling, mapping, or other reasons. The device 100 may similarly assist with management of grain stored in other bulk stores, many types of which have been described herein.

During load-in traversals of piled granular material, during a maintenance traversal of a surface of piled granular material, or during a load-out traversal of piled granular material, a robot 100 may utilize a sensor 120 of robot 100, acting under instruction/direction of host processor 102, to capture a measurement of a characteristic of the surface of piled granular material. Some example characteristics include, but are not limited to, capturing a measurement of: temperature, humidity, moisture, gas composition, electrostatic nature, and/or electrochemical nature. A measured characteristic may also comprise an optical and/or infrared image. The captured measurement of a characteristic can be stored within memory 103 or transmitted from robot 100. In some embodiments, the captured measurement of a characteristic is paired with a location of robot 100 at the time of capture of the measurement. Such paired data can be used to create a characteristic map of the piled grain which is traversed by robot 100. In a like fashion, the recorded positions of a robot 100 during one or more traversals may be utilized to create a three-dimensional map of the surface. This surface mapping may be referred to as a contour map and may include elevations of the contours.

In some embodiments, the captured measurement(s) of characteristic(s) may be transmitted to a base station (506, 605) that is/are communicatively coupled with robot 100. The base station (506, 605) is located remotely from the robot and may be configured to communicate with robot 100 over the Internet, via a wide-area network, via a peer-to-peer communication, or by other means. Via such communications, the base station (506, 605) may receive data collected by robot 100 (including motion sensor data) collected by the robot during the traversal of the portion of piled grain. Additionally, or alternatively, via such communications, the base station (506, 605) may relay instructions to robot 100.

In some embodiments, the captured measurement(s) of characteristic(s) may be transmitted to a cloud-based 602 storage 603 and/or processing 604 which is/are communicatively coupled with robot 100. The cloud-based infrastructure 602 may be utilized to process data, store data, make data available to other devices (e.g., computer 605), and/or relay information or instructions from other devices (e.g., computer 605) to robot 100.

### Section 3

### Management of Piled Granular Material Having a Vertical Projection

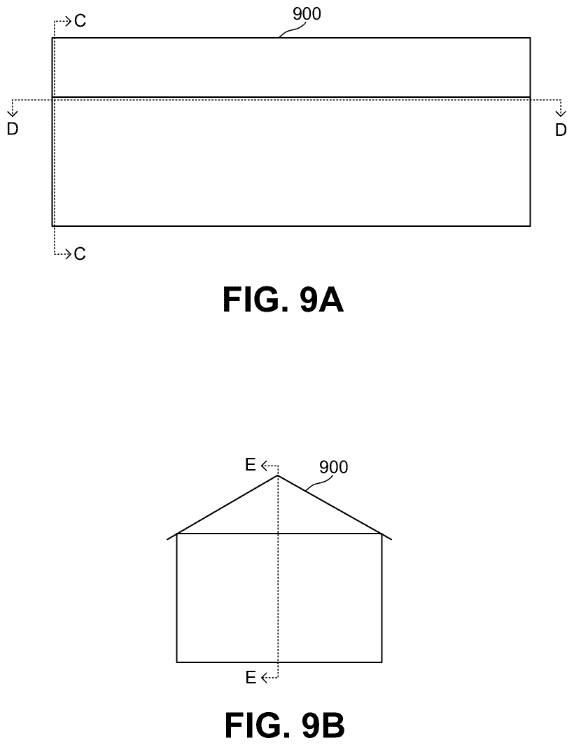

FIG. 9A is a front side elevational view of an example rectangular bulk store 900 within which granular material may be stored, in accordance with various embodiments.

FIG. 9B is a left side elevational view of the example rectangular bulk store 900, in accordance with various embodiments.

Section lines C-C, D-D, and E-E show the directions of various sectional views. Granular material stored in bulk store 900 may be of any sort and may include but is not limited to grain, non-grain bulk solids, non-grain plant seeds, nuts, nut shells, a pelletized product, a granular mineral product, a granular milled product, and a granular ground product. In some embodiments, the granular material stored in bulk store 900 may be, without limitation thereto, one of: sugar, flour, soy meal, dry fertilizer, cement, concrete mix, alumina, rice, sand, and salt.

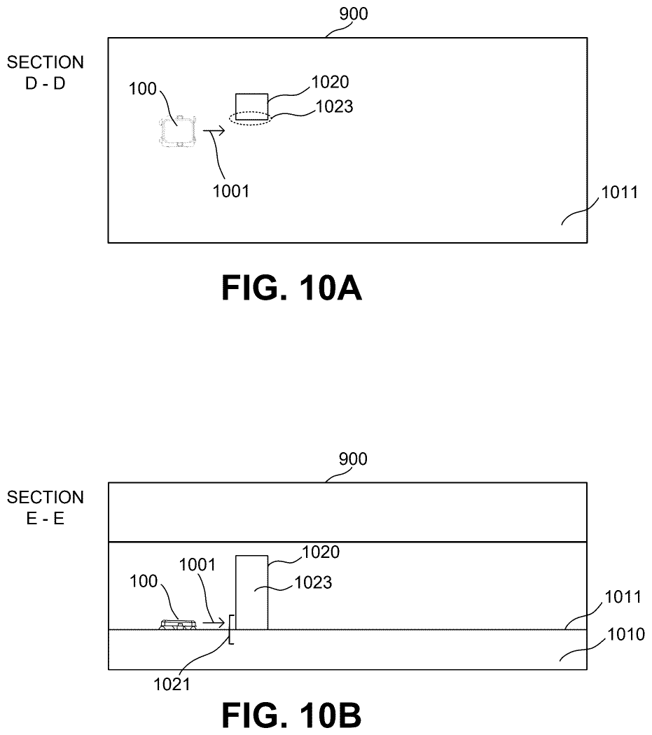

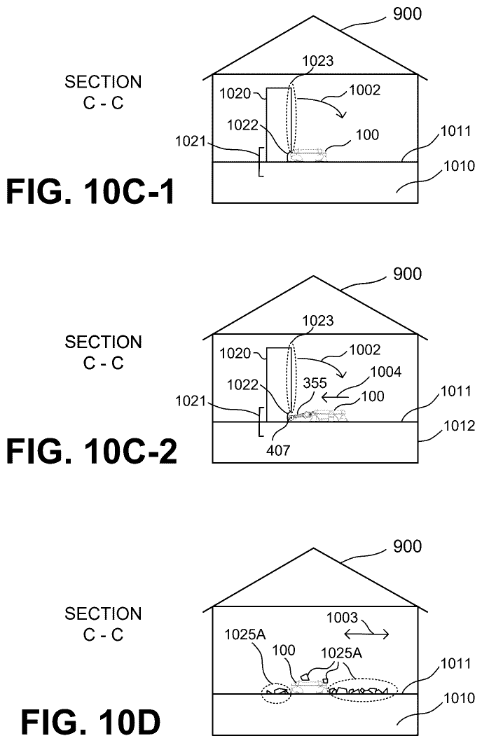

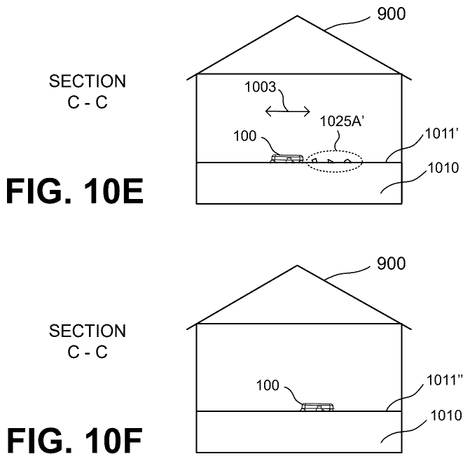

FIGS. 10A-10F illustrate various sectional views of the rectangular bulk store 900 of FIGS. 9A and 9B along with an example pile of granular material with the robot/device 100 of FIG. 4A1-4I performing piled granular material management in an environment which has a pillar of piled granular material projecting from the surface, in accordance with various embodiments. In the embodiments illustrated in FIGS. 10A-10F, a stand-alone pillar 1020 exists and robot 100 reduces it (i.e., makes it smaller or eliminates it), via gravity induced collapse, and then grinds up chunks of granular material in the resulting debris field into smaller pieces.

FIG. 10A illustrates section D-D, which is a top-down sectional view showing the inside of bulk store 900. A robot 100 is illustrated traversing surface 1011 in direction 1001 toward a sheer face 1023 of a stand-alone pillar 1020 of granular material. Such a stand-alone pillar may also be referred to as a tower. A sheer face 1023 is a portion which extends in a generally vertical direction upward from the surface 1011. In some embodiments, a sheer face is defined as a face of a generally vertical projection of granular material which may vary in slope, inward or outward, from purely vertically upward from surface 1011 within a predefined range such as: +/−3%, +/−5%, +/−10%, +/−15%, or some other predefined range. In some embodiments, a face is considered a “sheer face” if it is too steep to be climbed robot 100. In some embodiments, one or more sensors 120 (e.g., ultrasonic sensor 231, LIDAR 232, optical sensor 235, and/or infrared sensor 236) may be used to detect a sheer face during traversals, by robot 100, upon surface 1011. By “stand-alone” what is meant is that no side of the pillar 1020 directly contacts an interior side wall of the bulk store 900. Obviously, a pillar 1020 may have more than one sheer face, but for clarity and ease of discussion only sheer face 1023 is identified in FIG. 10A.

A vertical projection is a localized region of compacted granular material which extends generally vertically from the surrounding surface of granular material in a bulk store, such as bulk store 900. In some embodiments, when a localized region of compacted granular material exceeds a minimum height above a surrounding surface, it may be considered a vertical projection. For example, a vertical projection of granular material may be defined, in some embodiments, as compacted granular material which exceeds a minimum vertical height above the surrounding surface, such as by one foot, two feet, three feet, four feet, five feet, etc. In some embodiments, this minimum vertical height is a threshold height which is too tall, in a vertical dimension, for device 100 to climb a sheer face of the vertical projection. In some embodiments, the upper limit of the height is limited to an upper limit for how high granular material was piled in the bulk store when the vertical projection was formed.

In some embodiments, one or more sensors 120 (e.g., ultrasonic sensor 231, LIDAR 232, optical sensor 235, and/or infrared sensor 236) may be used to detect a sheer face, such as sheer face 1023, during a traversal by robot 100 upon surface 1011. For example, one or more of such sensors 120 can be used to determine that a vertical projection, which is not a wall of the bulk store 900, exists and is projecting upward from surface 1011. In some embodiments, such detection may result in robot 100 mapping the vertical projection associated with the sheer face 1023 such as by traversing around it to determine its location with respect to bulk store 900. Such mapping may be utilized to mark the sheer projection for future remediation, as a hazard to avoid, or for other reasons. In some embodiments, such detection of a sheer face 1023 may trigger the robot 100 to begin actions to reduce (make smaller and/or eliminate) the vertical projection associated with the sheer face 1023 in a manner described herein.

FIG. 10B illustrates section E-E, which is a front side sectional view showing the inside of bulk store 900. Robot 100 is illustrated traversing surface 1011 of granular material 1010 in direction 1001 toward the base 1021 of a stand-alone pillar 1020 of granular material. Stand-alone pillar 1020 projects, in a generally vertical direction, upward from surface 1011. Pillar 1020 is formed of granular material 1010 and poses both a difficulty in cleaning out bulk store 900, as it does not readily flow, and a danger as it might fall on a human if a human should enter bulk store to topple the pillar 1020 or for other reasons.

Herein the base 1021 is defined as a region rather than a point, and that region is at least a portion that is slightly above any point where a sheer face of stand-alone pillar 1020 meets the surface 1011, and in some embodiments is defined to encompass a region that is both slightly above and slightly below any point where a sheer face of stand-alone pillar 1020 meets the surface 1011.

In some embodiments, the base 1021 may be defined as a specific distance above any point where a sheer face of pillar 1020 meets with surface 1011. For example, in some embodiments, the distance may be specified as being up to four feet above any point where a sheer face of stand-alone pillar 1020 meets the surface 1011.

In some embodiments, the base 1021 may be defined as a specific distance above and below any point where a sheer face of pillar 1020 meets with surface 1011. For example, in some embodiments, the distance may be specified as being up to four feet above and up to four feet below any point where a sheer face of stand-alone pillar 1020 meets the surface 1011.

In other embodiments, the bounds of this region may be defined differently; for example, one foot above/below or five feet above/below, rather than four feet above/below. The bounds of what is considered the base may also be defined asymmetrically, such as 3 feet above the surface and up to one foot below or two feet above the surface and zero feet below. Obviously, the lower limit of any fixed distance may be reduced when the surface 1011 of the piled granular material is less than that distance above the floor of the bulk store 900. Likewise, the upper limit of what is considered to be the base is reduced if the range would exceed the height of the stand-alone pillar.

In other embodiments, the base 1021 may be defined as a region that is a percentage of the height that a sheer face of stand-alone pillar extends above surface 1011, rather than a fixed distance. For example, if the percentage is 10% and the stand-alone pillar 1020 is 60 feet in height, then the base 1021 may be defined as a region that is approximately six feet wide and encompasses a zone three feet above and three feet below any point where a sheer face of stand-alone pillar 1020 meets the surface 1011, in some embodiments. Various percentages may be used to define the bounds of the base 1021, such as 5% of the height, 10% of the height, 15% of the height, 25% of the height. Obviously, the lower limit of any percentage-based definition of the “base” may be reduced when the surface 1011 of the piled granular material is less than that distance above the floor of the bulk store 900.

FIGS. 10C-1 and 10C-2 illustrate various manners in which an auger or augers of a robot 100 may be employed to undercut a vertical projection of granular material, such as a pillar or cliff (in the illustration, a pillar is being undercut). Operations and techniques illustrated in FIGS. 10C-1 and 10C-2 may be employed individually or in combination, in various embodiments, to erode a segment near the base of a vertical projection of granular material, such as a portion of a pillar or cliff.

FIG. 10C-1 illustrates section C-C, which is a left side sectional view showing the inside of bulk store 900. Robot 100 is depicted being controlled and directed to traverse surface 1011 in a manner which facilitates an auger 403 of the bilateral augers intersecting and eroding, via auger agitation, a segment 1022 of the base 1021 of the stand-alone pillar 1020.

FIG. 10C-2 illustrates section C-C, which is a left side sectional view showing the inside of bulk store 900. FIG. 10C-2 shows the same undercutting, via erosion of segment 1022 as in FIG. 10C-1, except that robot 100 is fitted with an auger payload/implement 355 and is depicted being controlled and directed to traverse surface 1111 in a manner which facilitates auger 407 of auger implement 355 agitating and grinding a segment 1022 of the base 1021 of the stand-alone pillar 1020. In some embodiments, augers 403 of the auger-based drive system of robot 100 may be operated to propel robot 100 and auger 407 into pillar 1020 to increase the purchase of auger 407 into compacted granular material of pillar 1020.

The directed traversal may be controlled by host processor 102 via control of the direction of rotation and/or the speed of rotation of augers 403 of robot 100. As previously discussed, in various embodiments, for example, device 100 can operate via remote controlled instruction, autonomously, or some combination thereof. That is, in some embodiments, the instructions may be received wirelessly from a remotely located computer system (506, 605, 604, etc.) or wirelessly from a remote controller 501 operated by a human (i.e., a human may drive the robot 100 remotely). In some embodiments, the instructions may be preprogrammed into robot 100 such that it operates autonomously or semi-autonomously (i.e., with some human intervention).

Eroding the segment 1022 is similar to undercutting a tree when felling a tree, except that a tree is solid but the pillar is composed of compacted granular material. One or more passes may be traversed via the directed traversal to erode, via agitation with an auger (403/407), the segment 1022 deeply enough to cause the sheer face to collapse downward and/or generally in direction 1002. The collapse is gravity induced, meaning that the weight above eroded segment 1022 becomes too great for the compressed granular material in the pillar 1020 to sustain, resulting in incited collapse. The incited collapse can be a fall (like a felled tree would fall sideways in an arc in the direction of the undercut), a sluff (like a downward slide or avalanche) of a section that is cleaved off of pillar 1020, or some combination. Mechanical action of the fall and/or impact at the end of the fall causes the section of the pillar 1020 which falls to break into chunks. In some embodiments, as depicted, a single incited collapse may topple a stand-alone pillar 1020. In other embodiments, an incited collapse may only cause a part (i.e., a sub-section) of the pillar to collapse, and the described process may then be repeated with additional directed traversals in the same manner until the entire pillar is collapsed.

FIG. 10D illustrates section C-C, which is a left side sectional view showing the inside of bulk store 900 after the gravity induced collapse of pillar 1020 has occurred. As depicted, the gravity induced collapse results in a debris field composed of chunks 1025A of granular material, distributed upon surface 1011, which were previously part of pillar 1020. In the illustrated embodiment, the entire pillar 1020 collapsed, which can be understood as the pillar constituting only a single section which was collapsed all at once. In other embodiments, only a part of the pillar may collapse, and the actions previously described may be repeated, as required to collapse any uncollapsed section of the pillar 1020 which remains standing. As depicted, robot 100 can be directed to traverse the chunks 1025A (e.g., in directions shown by arrows 1003) such that augers 403 of the bilateral augers and/or auger 407 of auger implement 355 can break up the chunks 1025A into smaller chunks and loose granular material which is incorporated into surface 1011.

FIG. 10E illustrates section C-C, which is a left side sectional view showing the inside of bulk store 900 after the gravity induced collapse of pillar 1020 has occurred and after augers 403 and/or 407 have broken-down chunks 1025A into smaller chunks 1025A′ and loose granular material to form a partially leveled surface 1011′ via repeated traversal of the debris field of chunks 1025A, such as in the directions shown by arrows 1003.

FIG. 10F illustrates section C-C, which is a left side sectional view showing the inside of bulk store 900 after the gravity induced collapse of pillar 1020 has occurred and after augers 403 and/or 407 have fully broken-down chunks 1025A to form a leveled surface 1011″.

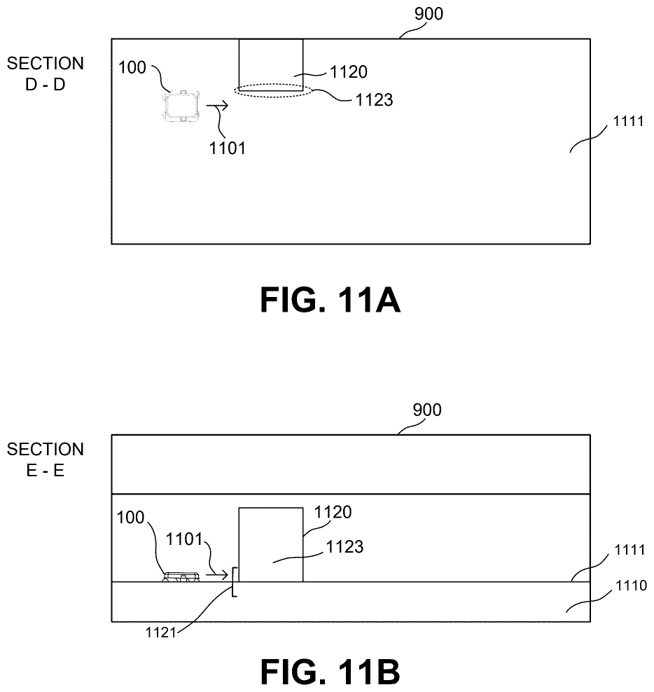

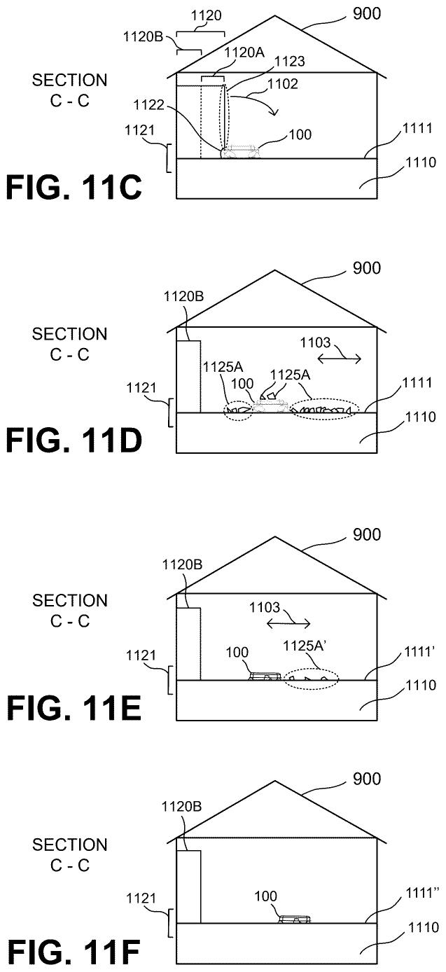

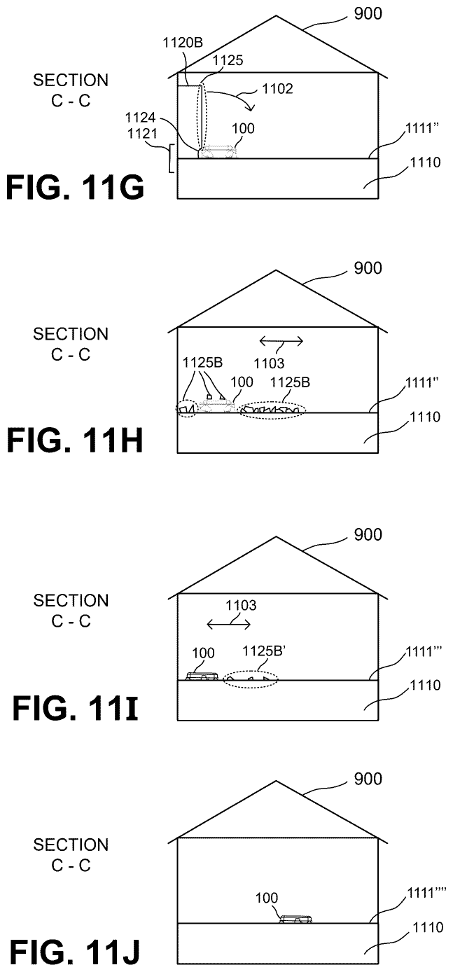

FIGS. 11A-11J illustrate various sectional views of the rectangular bulk store 900 of FIGS. 9A and 9B along with an example pile of granular material 1110 with the robot/device 100 of FIG. 4A1-4I performing piled granular material surface management in an environment which has a cliff 1120 of piled granular material projecting from the surface, in accordance with various embodiments. In the embodiments illustrated in FIGS. 11A-11J, a cliff 1120 exists and robot 100 reduced it (i.e., makes it smaller or eliminates it), via gravity induced collapse, and then grinds up the chunks of granular material in the resulting debris field into smaller pieces.

FIG. 11A illustrates section D-D, which is a top-down sectional view showing the inside of bulk store 900. A robot 100 is illustrated traversing surface 1111 in direction 1101 toward a sheer face 1123 of a cliff 1120 of granular material. By “cliff” what is meant is that at least one side of the vertical projection touches an interior side wall of bulk store 900. A sheer face 1123, similar to previously discussed sheer face 1023, is a portion of compressed granular material which extends in a generally vertical direction upward from the surface 1111. In some embodiments, a sheer face is defined as a face of a generally vertical projection of granular material which may vary in slope, inward or outward, from purely vertically upward from surface 1111 within a predefined range, such as: +/−3%, +/−5%, +/−10%, +/−15%, or some other predefined range. In some embodiments, a face is considered a “sheer face” if it is too steep to be climbed robot 100. Obviously, a cliff 1120 may have more than one sheer face, but for clarity and ease of discussion only one sheer face 1123 is identified in FIG. 11A.

As previously discussed, a vertical projection is a localized region of compacted granular material which extends generally vertically from the surrounding surface of granular material in a bulk store, such as bulk store 900. In some embodiments, when a localized region of compacted granular material exceeds a minimum height above a surrounding surface, it may be considered a vertical projection. For example, a vertical projection of granular material may be defined, in some embodiments, as compacted granular material which exceeds a minimum vertical height above the surrounding surface, such as by one foot, two feet, three feet, four feet, five feet, etc. In some embodiments, this minimum vertical height is a threshold height which is too tall, in a vertical dimension, for device 100 to climb a sheer face of the vertical projection. In some embodiments, the upper limit of the height is limited to an upper limit for how high granular material was piled in the bulk store when the vertical projection was formed.

In some embodiments, one or more sensors 120 (e.g., ultrasonic sensor 231, LIDAR 232, optical sensor 235, and/or infrared sensor 236) may be used to detect a sheer face, such as sheer face 1123, during a traversal by robot 100 upon surface 1111. For example, one or more of such sensors 120 can be used to determine that a vertical projection, which is not a wall of the bulk store 900, exists and is projecting upward from surface 1111. In some embodiments, such detection may result in robot 100 mapping the vertical projection associated with the sheer face 1123 such as by traversing around it to determine its location with respect to bulk store 900. Such mapping may be utilized to mark the sheer projection for future remediation, as a hazard to avoid, or for other reasons. In some embodiments, such detection of a sheer face 1123 may trigger the robot 100 to begin actions to reduce (make smaller and/or eliminate) the vertical projection associated with the sheer face 1123 in a manner described herein.

FIG. 11B illustrates section E-E, which is a front side sectional view showing the inside of bulk store 900. Robot 100 is illustrated traversing surface 1111 of granular material 1110 in direction 1101 toward the base 1121 of a cliff 1120 of granular material. Cliff 1120 projects, in a generally vertical direction, upward from surface 1111. Cliff 1120 is formed of granular material 1110 and poses both a difficulty in cleaning out bulk store 900, as it does not readily flow, and a danger as it might fall on a human if a human should enter bulk store to topple the cliff 1120 or for other reasons.

Herein the base 1121 is defined as a region rather than a point, and that region is at least a portion that is slightly above any point where a sheer face of cliff 1120 meets the surface 1111, and in some embodiments is defined to encompass a region that is both slightly above and slightly below any point where a sheer face of cliff 1120 meets the surface 1111.

In some embodiments, the base 1121 may be defined as a specific distance above any point where a sheer face of cliff 1120 meets with surface 1111. For example, in some embodiments, the distance may be specified as being up to four feet above any point where a sheer face of cliff 1120 meets the surface 1111.

In some embodiments, the base 1121 may be defined as a specific distance above and below any point where a sheer face of cliff 1120 meets with surface 1111. For example, in some embodiments, the distance may be specified as being up to four feet above and up to four feet below any point where a sheer face of cliff 1120 meets the surface 1111.

For example, in some embodiments, the distance may be specified as being four feet above and four feet below any point where a sheer face of the cliff meets the surface 1111. In other embodiments, the bounds of this region may be different; for example, one foot above/below or five feet above/below, rather than four feet above/below. The bounds of what is considered the base may also be defined asymmetrically, such as 3 feet above the surface and one foot below or two feet above the surface and zero feet below. Obviously, the lower limit of any fixed distance may be reduced when the surface 1111 of the piled granular material is less than that distance above the floor of the bulk store 900. Likewise, the upper limit considered the base is reduced if the range would exceed the height of the cliff.

In other embodiments, the base 1121 may be defined as a region that is a percentage of the height that the cliff extends above surface 1111, rather than a fixed distance. For example, if the percentage is 10% and the stand-alone cliff 1120 is 80 feet in height, then the base 1121 may be defined as a region that is approximately eight feet wide and encompasses a zone four feet above and up to four feet below any point where a sheer face of cliff 1120 meets the surface 1111, in some embodiments. Various percentages may be used to define the bounds of the base 1121, such as 3% of the height, 5% of the height, 10% of the height, 15% of the height, 25% of the height. Obviously, the lower limit of any percentage-based definition of the “base” may be reduced when the surface 1111 of the piled granular material is less than that distance above the floor of the bulk store 900.

FIG. 11C illustrates section C-C, which is a left side sectional view showing the inside of bulk store 900. Robot 100 is depicted being controlled and directed to traverse surface 1111 in a manner which facilitates an auger 403 of the bilateral augers intersecting and eroding, via auger agitation, a segment 1122 of the base 1121 of the cliff 1120. Cliff 1120 is illustrated as having a first section 1120A that is initially incited to collapse, and a second section 1120B that remains after the initial incited collapse. It should be appreciated that an auger 407 of an auger implement 355 may be additionally or alternatively employed to erode segment 1122 of section 1120A of cliff 1120 in a manner similar to that which was illustrated in FIG. 10C-2.

The directed traversal may be controlled by host processor 102 via control of the direction of rotation and/or the speed of rotation of augers 403 of robot 100. As previously discussed, in various embodiments, for example, device 100 can operate via remote controlled instruction, autonomously, or some combination thereof. That is, in some embodiments, the instructions may be received wirelessly from a remotely located computer system (506, 605, 604, etc.) or wirelessly from a remote controller 501 operated by a human (i.e., a human may drive the robot 100 remotely). In some embodiments, the instructions may be preprogrammed into robot 100 such that it operates autonomously or semi-autonomously (i.e., with some human intervention).

Eroding the segment 1122 is similar to undercutting a tree when felling a tree, except that a tree is solid but the cliff is composed of compacted granular material. One or more passes may be traversed via the directed traversal to erode, via agitation with an auger (403/407), the segment 1122 deeply enough to cause the sheer face to collapse downward and/or generally in direction 1102. The collapse is gravity induced, meaning that the weight above eroded segment 1122 becomes too great for the compressed granular material in the cliff 1120 to sustain, resulting in incited collapse of section 1120A. The incited collapse can be a fall (like a felled tree would fall sideways in the direction of the undercut), a sluff (like a downward slide or avalanche) of a section (e.g., 1120A) that is cleaved off of cliff 1120, or some combination. Mechanical action of the fall and/or impact at the end of the fall causes the section 1120A of the cliff 1120 which falls to break into chunks. In some embodiments, a single incited collapse may topple all of a cliff. In other embodiments, as depicted, an incited collapse may only cause a part (e.g., section 1120A) of the cliff 1120 to collapse, and the described process may then be repeated with additional directed traversals in the same manner until the entire cliff 1120 is collapsed.

FIG. 11D illustrates section C-C, which is a left side sectional view showing the inside of bulk store 900 after the gravity induced collapse of section 1120A of cliff 1120 has occurred leaving section 1120B standing along with a debris field composed of chunks 1125A of granular material, distributed upon surface 1111, which were previously part of section 1120A of cliff 1120. As depicted, robot 100 can be directed to traverse the chunks 1125A (e.g., in directions shown by arrows 1103) such that augers 403 of the bilateral augers and/or auger 407 of an implement 355 can break up the chunks 1125A into smaller chunks and loose granular material which is incorporated into surface 1111.

FIG. 11E illustrates section C-C, which is a left side sectional view showing the inside of bulk store 900 after the gravity induced collapse of cliff section 1120A has occurred and after augers 403 and/or 407 have broken-down chunks 1125A into smaller chunks 1125A′ and loose granular material to form a partially leveled surface 1111′ via repeated traversal of the debris field of chunks 1125A, such as in the directions shown by arrows 1103.

FIG. 11F illustrates section C-C, which is a left side sectional view showing the inside of bulk store 900 after the gravity induced collapse of cliff section 1120A has occurred and after augers 403 and/or 407 have fully broken-down chunks 1125A and 1125A′ to form a leveled surface 1111″.

FIG. 11G illustrates section C-C, which is a left side sectional view showing the inside of bulk store 900. Robot 100 is depicted being controlled and directed to traverse surface 1111″ in a manner which facilitates an auger 403 of the bilateral augers intersecting and eroding, via auger agitation, a segment 1124 of the base 1121 of the sheer face 1125 of section 1120B (which is all that remains of the original cliff 1120). In other embodiments, an auger 407 of an auger implement/payload 355 may additionally or alternatively be used to erode the segment 1124 of the base 1121 of section 1120B of cliff 1120 in a similar manner to that which was illustrated in FIG. 10C-2.

FIG. 11H illustrates section C-C, which is a left side sectional view showing the inside of bulk store 900 after the gravity induced collapse of section 1120B of cliff 1120 has occurred leaving a debris field composed of chunks 1125B of granular material, distributed upon surface 1111″, which were previously part of section 1120B of cliff 1120. As depicted, robot 100 can be directed to traverse the chunks 1125B (e.g., in directions shown by arrows 1103) such that augers 403 of the bilateral augers and/or auger 407 of an auger payload/implement 355 can break up the chunks 1125B into smaller chunks and loose granular material which is incorporated into surface 1111″.

FIG. 11E illustrates section C-C, which is a left side sectional view showing the inside of bulk store 900 after the gravity induced collapse of cliff section 1120B has occurred and after augers 403 and/or 407 have broken-down chunks 1125B into smaller chunks 1125B′ and loose granular material to form a partially leveled surface 1111″′ via repeated traversal of the debris field of chunks 1125B, such as in the directions shown by arrows 1103.

FIG. 11F illustrates section C-C, which is a left side sectional view showing the inside of bulk store 900 after the gravity induced collapse of cliff section 1120B has occurred and after augers 403 and/or 407 have fully broken-down chunks 1125B and 1125B′ to form a leveled surface 1111″″.

### Example Methods of Management of Piled Granular Material

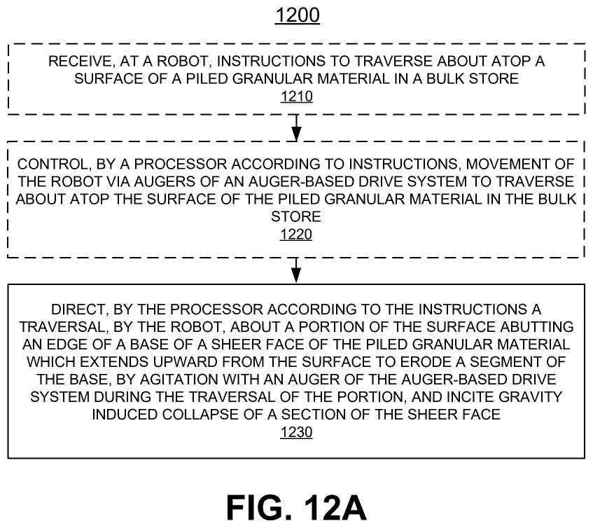

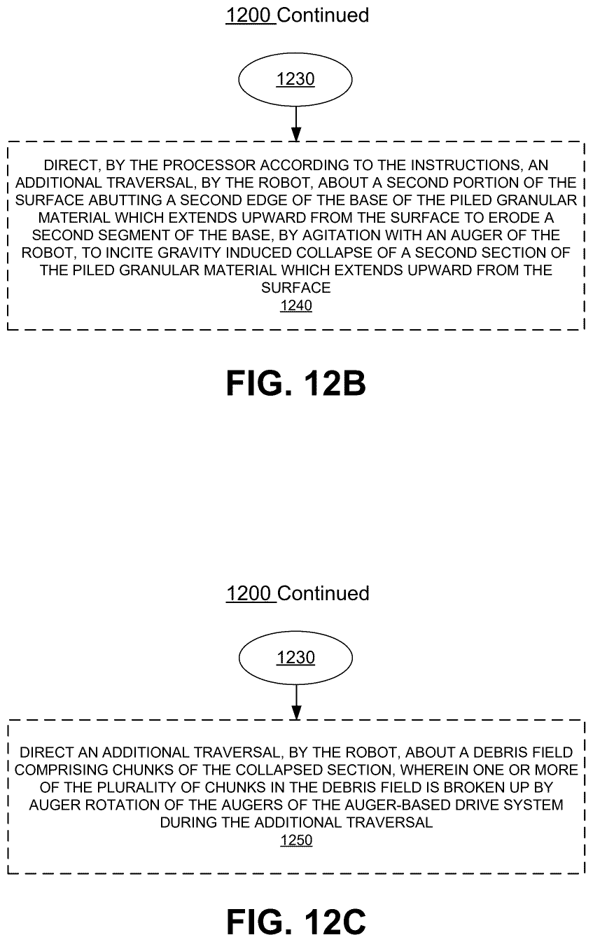

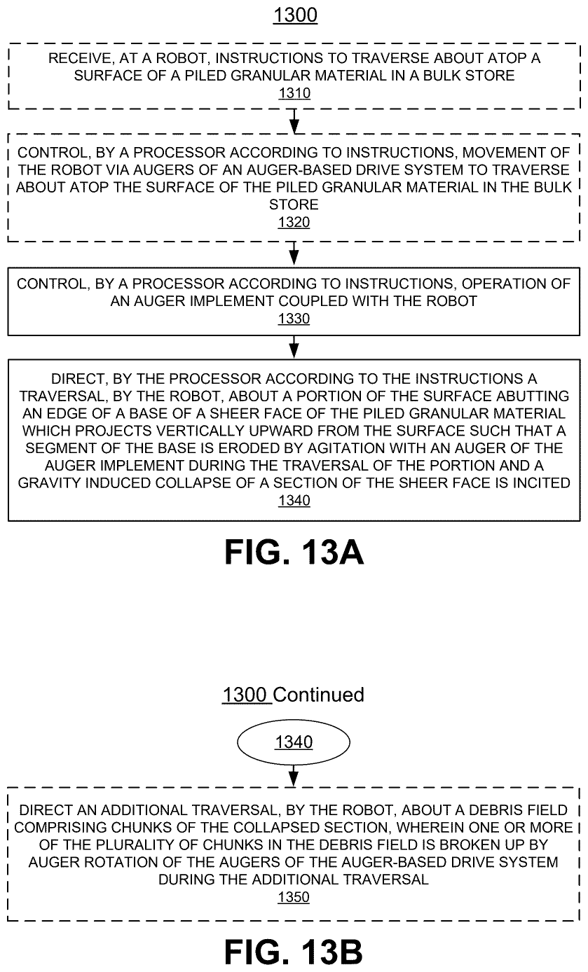

FIGS. 12A-12C illustrate a flow diagram 1200 of an example method of piled granular material management of a surface which has one or more vertical projections of granular material, in accordance with various embodiments. FIGS. 13A-13B illustrate a flow diagram 1300 of an example method of piled granular material management of a surface which has one or more vertical projections of granular material, in accordance with various embodiments. The vertical projections may be one or more cliffs, pillars, or some combination these and/or other similar vertical projections of granular material. Procedures of the methods illustrated by flow diagram 1200 and flow diagram 1300 will be described with reference to elements and/or components of one or more of FIGS. 1-11J. In various embodiments, the procedures of flow diagrams 1200 and/or 1300 may be performed independently in a bulk store or as an additional task during one or more of: load-in of granular material, leveling of granular material, mapping of granular material, maintenance of the surface of piled granular material which occurs in a storage period between load-in and load-out of piled granular material, traversal to break up a crust on the surface of piled granular material, traversal to prevent the formation of a crust on the surface of a granular material, and/or during or after the load-out of some amount of piled granular material. It is appreciated that in some embodiments, the procedures of flow diagrams 1200 and/or 1300 may be performed in a different order than described in a flow diagram, that some of the described procedures may not be performed, and/or that one or more additional procedures to those described may be performed. Flow diagrams 1200 and 1300 include some procedures that, in various embodiments, are carried out by one or more processors (e.g., host processor 102 or any processor of device 100 and/or a computer or system to which device 100 is communicatively coupled) under the control of computer-readable and computer-executable instructions that are stored on non-transitory computer-readable storage media (e.g., host memory 103, other internal memory of device 100, or memory of a computer or system to which device 100 is communicatively coupled). It is further appreciated that one or more procedures described in flow diagram 1200 and/or flow diagram 1300 may be implemented in hardware, or a combination of hardware with firmware and/or software.

The procedures of flow diagram 1200 and flow diagram 1300 will be described with reference to a piled granular material management robot (e.g., robot 100) which is controllable to move about relative to, upon, and/or atop the surface of a piled granular material. Robot 100 comprises a body 401; an auger-based drive system coupled with the body 401 and comprising a plurality of augers 403; a memory 203; and a processor 102 coupled with the memory 103. The auger-based drive system includes, for example, drive motors 106 and augers 403, and may include transmissions 402. In some embodiments, motor controllers 105 may also be considered a portion of an auger-based drive system. The augers of the auger-based drive system may be bilateral or may have other arrangements and may include more than two augers. In some embodiments, the robot 100 may also be outfitted with an auger payload/implement 355 (see e.g., FIG. 4H) which includes an auger 407 which is separate from the augers 403 of the auger-based drive system of robot 100.

With reference to FIG. 12A, at procedure 1210 of flow diagram 1200, in various embodiments, instructions are received at robot 100. In some embodiments, the instructions are to traverse a portion of a surface of a piled granular material in a bulk store such as bulk store 900 of FIGS. 9A-11J. In some embodiments, the instructions are to operate an auger implement/payload 355 which is coupled with the robot 100. In some embodiments, the instructions may be received wirelessly from a remotely located computer system (506, 605, 604, etc.) or wirelessly from a remote controller 501 operated by a human (i.e., a human may drive the robot 100 remotely). In some embodiments, the instructions may be preprogrammed into robot 100. In some embodiments, the instructions are for the robot 100 to follow a predetermined pattern of movement to traverse the surface of the piled grain. In some embodiments, instructions may direct the robot 100 to operate in an autonomous or semi-autonomous mode. The instructions may cause the robot to perform tasks such as traversing piled granular material, traversing piled granular material to map the surface or collect data with sensors of robot 100, traversing piled granular material to level or otherwise adjust the slope of the piled granular material, traversing piled granular material to break up a crust or prevent crust formation, traversing the granular material to assist with load-in or load-out, and/or reducing (e.g., toppling, collapsing) vertical surface projections of granular material. The bulk store may enclosed or unenclosed (i.e., at least partially open air, such as with no roof) and be any type of bulk store, many examples of which are described herein. In some embodiments, where the robot 100 is operating in an autonomous or semi-autonomous mode, this procedure may not be performed.

With continued reference to FIG. 12A, at procedure 1220 of flow diagram 1200, in various embodiments, movement of the piled granular material management robot 100, is directed, via the augers of the auger-based drive system, to traverse about atop a surface of a piled granular material in a bulk store. The movement may be directed by a processor (e.g., processor 102 of robot 100), according to instructions. The augers of the drive system may be bilateral, or may have other arrangements (e.g., augers on four sides of robot 100, augers on three sides of robot 100, three parallel augers, etc.). FIGS. 10A and 10B illustrate examples of controlling the movement of a robot 100 (e.g., a granular material management robot), via the augers of the auger-based drive system, to traverse about a surface 1011 of a piled granular material 1010 in a bulk store 900. FIGS. 11A and 11B illustrate examples of controlling the movement of a robot 100 (e.g., a granular material management robot), via the augers of the auger-based drive system, to traverse about a surface 1111 of a piled granular material 1110 in a bulk store 900. The piled granular material 1010/1110 may be grain or a non-grain bulk solid. Some non-limiting examples of categories of non-grain bulk solids include, without limitation thereto: non-grain plant seeds, nuts, nut shells, a pelletized product, a granular mineral product, a granular milled product, and a granular ground product. In some embodiments, without limitation thereto, the piled granular material may be one of: sugar, flour, soy meal, dry fertilizer, cement, concrete mix, alumina, rice, sand, and salt. In some embodiments, where a robot 100 is already properly positioned for the movement/erosion described in procedure 1230, this procedure may not be performed. Such “proper positioning” may occur, in some embodiments, when a vertical projection of piled granular material is encountered or detected by robot 100 during the conduct of another task, such as leveling, mapping, breaking up crusts, or preventing crust formation.

With continued reference to FIG. 12A, at procedure 1230 of flow diagram 1200, in various embodiments, movement of the robot 100 is directed via augers 403 of the auger-based drive system such that it performs a traversal about a portion of the surface abutting an edge of a base of a sheer face of the piled granular material which projects vertically upward from the surface. This may comprise traversing along adjacent to the base of a sheer face of a vertical projection at a speed and in a direction so that a segment of the base is eroded, by an auger 403, across all or part of the vertical projection as a function of the traversal. The movement may be directed by a processor (e.g., processor 102 of robot 100), according to instructions. In other embodiments, the movement is directed autonomously by robot 100 in response to sensors of robot 100 detecting the sheer face/vertical projection. In some embodiments, traversal is directed such that it erodes a segment of the base of the projection, by agitation with an auger 403 of the auger-based drive system of the robot 100 during the traversal of the portion and/or with an auger 407 of an auger implement 355. This erosion undercuts the sheer face and incites a gravity induced collapse of a section of the sheer face. In some embodiments, the sheer face is a sheer face of a stand-alone pillar (e.g., sheer face 1023 of pillar 1020 illustrated in FIGS. 10A-10C-2). In some embodiments, the sheer face is a sheer face of a cliff (e.g., sheer face 1123 of cliff 1120 illustrated in FIGS. 11A-11C). FIG. 10C-1 illustrates the erosion, via auger agitation by an auger 403 of robot 100, of a segment 1022 of base 1021 and the resulting gravity induced collapse of a pillar 1020. FIG. 10C-2 illustrates the erosion, via auger agitation by an auger 407 of an auger implement 355 of robot 100, of a segment 1022 of base 1021 and the resulting gravity induced collapse of a pillar 1020. FIG. 11C illustrates the erosion, via auger agitation by robot 100, of a segment 1122 of base 1121 and the resulting gravity induced collapse of a section 1120A of a cliff 1120. In other embodiments as illustrated in FIG. 10C-2, an auger 407 of an auger payload/implement 355 which is coupled with robot 100 may be additionally or alternatively utilized to erode all or a portion of the segment 1022 and/or segment 1122.

With reference to FIG. 12B, in procedure 1240 of flow diagram 1200, in some embodiments, the method as recited in 1210-1230, further comprises the processor directing an additional traversal, by the piled granular material management robot 100, about a second portion of the surface abutting a second edge of the base of the piled granular material which projects vertically upward from the surface. The additional traversal may be directed by a processor (e.g., processor 102 of robot 100). This additional traversal is directed such that the traversal of the second portion erodes a second segment of the base, by agitation with an auger of the piled granular material management robot 100, to incite gravity induced collapse of a second section of the piled granular material which projects vertically upward from the surface. In various embodiments, the auger may be an auger 403 of the auger-based drive system and/or an auger 407 of an auger payload/implement 355. FIG. 11G illustrates the erosion, via auger agitation by robot 100, of a segment 1124 of base 1121 and the resulting gravity induced collapse of a section 1120B of a cliff 1120. In other embodiments, as illustrated in FIG. 10C-2, an auger 407 of an auger payload/implement 355, may be coupled with robot 100 and may similarly be utilized to erode all or a portion of a segment such as segment 1022 and/or segment 1122.

With reference to FIG. 12C, in procedure 1250 of flow diagram 1200, in some embodiments, the method as recited in 1210-1230, further comprises directing an additional traversal, by the robot, about a debris field when the gravity induced collapse of the section of the sheer face results in a debris field on the surface and the debris field comprises a plurality of chunks from the collapsed section. The additional traversal may be directed by a processor (e.g., processor 102 of robot 100). During the additional traversal, one or more of the plurality of chunks in the debris field is broken up by auger rotation of the augers of the auger-based drive system. That is, the auger rotation agitates and pulverizes the chunks of debris into smaller chunks and/or loose granular material. In some embodiments, the debris may additionally or alternatively be broken up by auger rotation of an auger 407 of an auger payload/implement 355. FIGS. 10D-10F illustrate the break-down of chunks 1025 of granular material in a debris field which resulted from the incited collapse of a stand-alone pillar. FIGS. 11D-11F illustrate the break-down of chunks 1125A of granular material in a debris field which resulted from the incited collapse of section 1120A of cliff 1120. FIGS. 11H-11J illustrate the break-down of chunks 1125B of granular material in a debris field which resulted from the incited collapse of section 1120B of cliff 1120.

With reference to FIG. 13A, at procedure 1310 of flow diagram 1300, in various embodiments, instructions are received at robot 100. In some embodiments, the instructions are to traverse a portion of a surface of a piled granular material in a bulk store such as bulk store 900 of FIGS. 9A-11J. In some embodiments, the instructions are to operate an auger implement/payload 355 which is coupled with the robot 100. In some embodiments, the instructions may be received wirelessly from a remotely located computer system (506, 605, 604, etc.) or wirelessly from a remote controller 501 operated by a human (i.e., a human may drive the robot 100 remotely). In some embodiments, the instructions may be preprogrammed into robot 100. In some embodiments, the instructions are for the robot 100 to follow a predetermined pattern of movement to traverse the surface of the piled grain. In some embodiments, instructions may direct the robot 100 to operate in an autonomous or semi-autonomous mode. The instructions may cause the robot to perform tasks such as traversing piled granular material, traversing piled granular material to map the surface or collect data with sensors of robot 100, traversing piled granular material to level or otherwise adjust the slope of the piled granular material, traversing piled granular material to break up a crust or prevent crust formation, and/or reducing (e.g., toppling, collapsing) vertical surface projections of granular material.

With continued reference to FIG. 13A, at procedure 1320 of flow diagram 1300, in various embodiments, movement of the piled granular material management robot 100, is directed, via the augers of the auger-based drive system. The movement may be directed by a processor (e.g., processor 102 of robot 100), according to instructions. The augers of the drive system may be bilateral, or may have other arrangements (e.g., augers on four sides of robot 100, augers on three sides of robot 100, three parallel augers, etc.). FIGS. 10A and 10B illustrate examples of controlling the movement of a robot 100 (e.g., a granular material management robot), via the augers of the auger-based drive system, to traverse about a surface 1011 of a piled granular material 1010 in a bulk store 900. FIGS. 11A and 11B illustrate examples of controlling the movement of a robot 100 (e.g., a granular material management robot), via the augers of the auger-based drive system, to traverse about a surface 1111 of a piled granular material 1110 in a bulk store 900. The piled granular material 1010/1110 may be grain or a non-grain bulk solid. Some non-limiting examples of categories of non-grain bulk solids include, without limitation thereto: non-grain plant seeds, nuts, nut shells, a pelletized product, a granular mineral product, a granular milled product, and a granular ground product. In some embodiments, without limitation thereto, the piled granular material may be one of: sugar, flour, soy meal, dry fertilizer, cement, concrete mix, alumina, rice, sand, and salt. In some embodiments, where the robot is already positioned properly, no movement is required or directed and this procedure may not be performed. Such “proper positioning” may occur, in some embodiments, when a vertical projection of piled granular material is encountered during the conduct of another task, such as leveling, mapping, breaking up crusts, or preventing crust formation.

In some embodiments, the movement is a traversal that is directed such that it erodes a segment of the base of the vertical projection, by agitation with an auger 403 of the auger-based drive system of the robot 100 during the traversal of the portion of the surface. This erosion, with an auger 403, may initially undercut the sheer face but does not undercut it enough so that it incites a gravity induced collapse of a section of the sheer face. Additional erosion by an auger implement 355 may utilized to more deeply erode the undercut 1022. In some embodiments, the sheer face is a sheer face of a stand-alone pillar (e.g., sheer face 1023 of pillar 1020 illustrated in FIGS. 10A-10C-2). In some embodiments, the sheer face is a sheer face of a cliff (e.g., sheer face 1123 of cliff 1120 illustrated in FIGS. 11A-11C). FIG. 10C-1 illustrates the erosion, via auger agitation by an auger 403 of robot 100, of a segment 1022 of base 1021 and the resulting gravity induced collapse of a pillar 1020. FIG. 11C illustrates the erosion, via auger agitation by an auger 403 of robot 100, of a segment 1122 of base 1121 of a cliff 1120.

In some embodiments, the movement is a traversal that is directed such that it positions robot 100 proximate the base 1021/1121 of a vertical projection of granular material such that an auger 407 of auger implement 355 is in the proper orientation to engage into and erode an undercut into a sheer face 1023/1123. In some embodiments, this comprises positioning auger 407 into an undercut 1022/1122 which was initiated by an auger 403 of the auger-based drive system.

With continued reference to FIG. 13A, at procedure 1330 of flow diagram 1300, in various embodiments, operation of an auger implement (e.g., implement 355) coupled with the robot 100 is controlled. For example, an auger implement 355 may be raised, lowered, turned on (i.e., start rotating the auger 407), turned off (i.e., stop rotating the auger 407), caused to rotate the auger in a first direction, caused to rotate the auger in a second direction opposite the first direction, caused to speed up rotation of the auger, and/or caused to slow down rotation of the auger. The auger implement 355 may be controlled and its movement may be directed by a processor (e.g., processor 102 of robot 100), according to instructions. In some embodiments, the auger 407 of auger implement 355 is controlled in this manner to agitate granular material in segment 1022/1122 of a sheer face 1023/1123 of a vertical projection of granular material. That is, it may be turned on and positioned such that it agitates and erodes granular material in a desired location (e.g., a location associated with segment 1022/1122). FIG. 10C-2 illustrates the erosion, via auger agitation by an auger 407 of an auger implement 355 of robot 100, of a segment 1022 of base 1021 and the resulting gravity induced collapse of a pillar 1020. In some embodiments, this eroded segment 1022/1122 may be completely eroded, from start to finish, by auger 407. In some embodiments, this eroded segment 1022/1122 may be further eroded by auger 407 from an initial erosion by an auger 403 started by the auger-based drive system of robot 100.

With continued reference to FIG. 13A, at procedure 1340 of flow diagram 1300, in various embodiments, a traversal, by the robot, is directed about a portion of the surface abutting an edge of a base of a sheer face of the piled granular material which projects vertically upward from the surface such that a segment of the base is eroded by agitation with an auger of the auger implement during the traversal of the portion of the surface and a gravity induced collapse of a section of the sheer face is incited. This direction may be provided by a processor (e.g., processor 102 of robot 100), according to instructions. In some embodiments, the movement is a traversal to initially position auger 407 to erode a segment 1022/1122 or to reposition it during the erosion. In some embodiments, the movement is a traversal that is directed such that while auger 407 is eroding an undercut 1022/1122 into the base 1021/1121 of a vertical projection of granular material, the augers 403 of the auger-based drive system propel robot 100 and auger 407 toward the sheer face of the vertical projection to increase the purchase of auger 407 so that an undercut can be deepened and/or to provide assistance (via a pushing force) in eroding very densely packed granular material. Examples of these aspects are depicted in FIG. 10C-2 by movement in direction 1004.

In embodiments, where a section of a vertical projection of granular material, such as a pillar or cliff, is collapsed in the manner described in procedures 1310-1340, the procedures may be repeated to perform additional traversals and undercuts to collapse one or more additional sections if a complete collapse of a vertical projection of granular material or of all vertical projections of granular material was not already achieved.

With reference to FIG. 13B, in procedure 1350 of flow diagram 1300, in some embodiments, the method as recited in 1310-1340, further comprises directing an additional traversal, by the robot, about a debris field when the gravity induced collapse of the all or a section of the sheer face results in a debris field on the surface and the debris field comprises a plurality of chunks from the collapsed section. The additional traversal may be directed by a processor (e.g., processor 102 of robot 100) based on instructions that are stored in the robot, autonomously generated by the robot, or wirelessly receive by the robot. During the additional traversal, one or more of the plurality of chunks in the debris field is broken up by auger rotation of the augers of the auger-based drive system. That is, the auger rotation agitates and pulverizes the chunks of debris into smaller chunks and/or loose granular material. In some embodiments, the debris may additionally or alternatively be broken up by auger rotation of an auger 407 of an auger payload/implement 355. FIGS. 10D-10F illustrate the break-down of chunks 1025 of granular material in a debris field which resulted from the incited collapse of a stand-alone pillar. FIGS. 11D-11F illustrate the break-down of chunks 1125A of granular material in a debris field which resulted from the incited collapse of section 1120A of cliff 1120. FIGS. 11H-11J illustrate the break-down of chunks 1125B of granular material in a debris field which resulted from the incited collapse of section 1120B of cliff 1120.

### Conclusion

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed:

1. A piled granular material management robot comprising:
an auger-based drive system;
a memory; and
a processor coupled with the memory and configured to:
control movement of the piled granular material management robot, via the auger-based drive system, to traverse about atop a surface of a piled granular material in a bulk store; and
direct a traversal, by the piled granular material management robot, about a portion of the surface abutting an edge of a base of a sheer face of the piled granular material which projects vertically upward from the surface, such that the traversal of the portion erodes a segment of the base, by agitation with an auger of the auger-based drive system during the traversal of the portion, and incites a gravity induced collapse of a section of the sheer face.

2. The piled granular material management robot of claim 1, wherein the processor is further configured to:
direct an additional traversal, by the piled granular material management robot, about a second portion of the surface abutting a second edge of the base of the piled granular material which projects vertically upward from the surface, such that the traversal of the second portion erodes a second segment of the base, by agitation with the auger, to incite gravity induced collapse of a second section of the piled granular material which projects vertically upward from the surface.

3. The piled granular material management robot of claim 1, wherein the gravity induced collapse of the section of the sheer face results in a debris field, on the surface, comprising a plurality of chunks of the collapsed section and the processor is further configured to:
direct an additional traversal, by the piled granular material management robot, about the debris field, wherein one or more of the plurality of chunks in the debris field is broken up by auger rotation of augers of the auger-based drive system during the additional traversal.

4. The piled granular material management robot of claim 1, wherein the sheer face is the sheer face of a cliff formed of the piled granular material and extending upward from the surface.

5. The piled granular material management robot of claim 1, wherein the sheer face is the sheer face of a stand-alone pillar formed of the piled granular material and extending upward from the surface.

6. The piled granular material management robot of claim 5, wherein the gravity induced collapse of the section of the sheer face comprises a collapse of the stand-alone pillar.

7. The piled granular material management robot of claim 1, wherein the piled granular material is selected from the list of piled granular material consisting of: sugar, flour, soy meal, dry fertilizer, cement, concrete mix, alumina, rice, sand, and salt.

8. The piled granular material management robot of claim 1, wherein the piled granular material is selected from the list of piled granular material consisting of: grain, non-grain plant seeds, nuts, nut shells, a pelletized product, a granular mineral product, a granular milled product, and a granular ground product.

9. A method of piled granular material management, the method comprising:
receiving at a robot, instructions to traverse a surface of a piled granular material in a bulk store;
controlling, by a processor according to instructions, movement of the robot via an auger-based drive system to traverse about the surface of the piled granular material in the bulk store; and
directing, by the processor according to the instructions, a traversal by the robot about a portion of the surface abutting an edge of a base of a sheer face of the piled granular material which projects vertically upward from the surface, such that the traversal of the portion erodes a segment of the base, by agitation with an auger of the auger-based drive system during the traversal of the portion, and incites a gravity induced collapse of a section of the sheer face.

10. The method as recited in claim 9, further comprising:
directing, by the processor according to the instructions, an additional traversal, by the robot, about a second portion of the surface abutting a second edge of the base of the piled granular material which projects vertically upward from the surface, such that the traversal of the second portion erodes a second segment of the base, by agitation with the auger, to incite gravity induced collapse of a second section of the piled granular material which projects vertically upward from the surface.

11. The method as recited in claim 9, wherein the gravity induced collapse of the section of the sheer face results in a debris field, on the surface, comprising a plurality of chunks from the collapsed section and the method further comprises:
directing an additional traversal, by the robot, about the debris field, wherein one or more of the plurality of chunks in the debris field is broken up by auger rotation of augers of the auger-based drive system during the additional traversal.

12. The method as recited in claim 9, wherein the directing, by the processor according to the instructions, a traversal by the robot about a portion of the surface abutting an edge of a base of a sheer face of the piled granular material which extends upward from the surface, such that the traversal of the portion erodes a segment of the base, by agitation with an auger of the auger-based drive system during the traversal of the portion, and incites a gravity induced collapse of a section of the sheer face comprises:
directing, by the processor according to the instructions, the traversal by the robot about the portion of the surface abutting the edge of the base of the sheer face of the piled granular material which projects vertically upward from the surface, such that the traversal of the portion erodes the segment of the base, by agitation with the auger of the auger-based drive system during the traversal of the portion, and incites the gravity induced collapse of the section of the sheer face of a cliff formed of the piled granular material and extending upward from the surface of the piled granular material.

13. The method as recited in claim 9, wherein the directing, by the processor according to the instructions, a traversal by the robot about a portion of the surface abutting an edge of a base of a sheer face of the piled granular material which projects vertically upward from the surface, such that the traversal of the portion erodes a segment of the base, by agitation with an auger of the auger-based drive system during the traversal of the portion, and incites a gravity induced collapse of a section of the sheer face comprises:
directing, by the processor according to the instructions, the traversal by the robot about the portion of the surface abutting the edge of the base of the sheer face of the piled granular material which projects vertically upward from the surface, such that the traversal of the portion erodes the segment of the base, by agitation the auger of the auger-based drive system during the traversal of the portion, and incites the gravity induced collapse of the section of the sheer face of a stand-alone pillar formed of the piled granular material and extending upward from the surface of the piled granular material.

14. The method as recited in claim 9, wherein the piled granular material is selected from the list of piled granular material consisting of: sugar, flour, soy meal, dry fertilizer, cement, concrete mix, alumina, rice, sand, and salt.

15. The method as recited in claim 9, wherein the piled granular material is selected from the list of piled granular material consisting of: grain, non-grain plant seeds, nuts, nut shells, a pelletized product, a granular mineral product, a granular milled product, and a granular ground product.

16. A non-transitory computer readable storage medium comprising instructions embodied thereon which, when executed, cause a processor to perform a method of piled granular material management, the method comprising:
receiving at a robot, instructions to traverse a surface of a piled granular material in a bulk store;
controlling, by a processor according to instructions, movement of the robot via an auger-based drive system to traverse about the surface of the piled granular material in the bulk store; and
directing, by the processor according to the instructions, a traversal by the robot about a portion of the surface abutting an edge of a base of a sheer face of the piled granular material which projects vertically upward from the surface, such that the traversal of the portion erodes a segment of the base, by agitation with an auger of the auger-based drive system during the traversal of the portion, and incites a gravity induced collapse of a section of the sheer face.

17. The non-transitory computer readable storage medium of claim 16, wherein the method further comprises:
directing, by the processor according to the instructions, an additional traversal, by the robot, about a second portion of the surface abutting a second edge of the base of the piled granular material which projects vertically upward from the surface, such that the traversal of the second portion erodes a second segment of the base, by agitation with the auger, to incite gravity induced collapse of a second section of the piled granular material which projects vertically upward from the surface.

18. The non-transitory computer readable storage medium of claim 16, wherein the gravity induced collapse of the section of the sheer face results in a debris field, on the surface, comprising a plurality of chunks from the collapsed section and the method further comprises:
directing, by the processor according to the instructions, an additional traversal, by the robot, about the debris field, wherein one or more of the plurality of chunks in the debris field is broken up by auger rotation of augers of the auger-based drive system during the additional traversal.

19. The non-transitory computer readable storage medium of claim 16, wherein the directing, by the processor according to the instructions, a traversal by the robot about a portion of the surface abutting an edge of a base of a sheer face of the piled granular material which projects vertically upward from the surface, such that the traversal of the portion erodes a segment of the base, by agitation with an auger the auger-based drive system during the traversal of the portion, and incites a gravity induced collapse of a section of the sheer face comprises:
directing, by the processor according to the instructions, the traversal by the robot about the portion of the surface abutting the edge of the base of the sheer face of the piled granular material which projects vertically upward from the surface, such that the traversal of the portion erodes the segment of the base, by agitation with the auger of the auger-based drive system during the traversal of the portion, and incites the gravity induced collapse of the section of the sheer face of a cliff formed of the piled granular material and extending upward from the surface of the piled granular material.

20. The non-transitory computer readable storage medium of claim 16, wherein the directing, by the processor according to the instructions, a traversal by the robot about a portion of the surface abutting an edge of a base of a sheer face of the piled granular material which projects vertically upward from the surface, such that the traversal of the portion erodes a segment of the base, by agitation with an auger of the auger-based drive system during the traversal of the portion, and incites a gravity induced collapse of a section of the sheer face comprises:
directing, by the processor according to the instructions, the traversal by the robot about the portion of the surface abutting the edge of the base of the sheer face of the piled granular material which projects vertically upward from the surface, such that the traversal of the portion erodes the segment of the base, by agitation with the auger of the auger of the auger-based drive system during the traversal of the portion, and incites the gravity induced collapse of the section of the sheer face of a stand-alone pillar formed of the piled granular material and extending upward from the surface of the piled granular material.
